(19) United States
(12) Patent Application Publication
(10) Pub. No.: US 2007/0091437 A1
(43) Pub. Date: Apr. 26, 2007

(54) Reflective polarizer, laminated optical member, and liquid crystal display apparatus

(75) Inventors: Toshiyuki Watanabe, Tokyo (JP); Kenro Totani, Tokyo (JP); Hideki Hayashi, Tokyo (JP); Masaaki Kubota, Ibaraki (JP); Masamitsu Ishitobi, Ibaraki (JP); Yoshiki Matsuoka, Ehime (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited

(21) Appl. No.: 10/565,191

(22) PCT Filed: Jul. 22, 2004
(86) PCT No.: PCT/JP04/10403

§ 371 Date: Aug. 15, 2006

(30) Foreign Application Priority Data
Jul. 22, 2003 (JP) 2003-199655
Jun. 24, 2004 (JP) 2004-186036

(51) Int. Cl. G02B 27/28; G02B 5/30

(52) U.S. Cl. 359/487

(57) ABSTRACT

It is an object to provide an optical member capable of enhancing efficiency of utilization of light in a liquid crystal display apparatus by laminating a reflective polarizer with an optical layer having another optical function, and it is another object to provide a liquid crystal display apparatus with increased efficiency of utilization of light from a backlight, using the laminated optical member with the reflective polarizer. The present invention provides a reflective polarizer comprising birefringent bodies including polygonal prisms or circular cylinders a shape of a cross section of which perpendicular to a long axis direction is polygonal or substantially circular, which has an aspect ratio of not less than 2, and which has a refractive index difference of not less than 0.05 between a refractive index in the long axis direction and a refractive index in a short axis direction. The birefringent bodies are dispersedly arranged substantially in an identical direction in a support medium, and where the shape of the cross section perpendicular to the long axis direction of the birefringent bodies is substantially circular, any one of the birefringent bodies, when viewed on the cross section, is in contact on a side face of a circular cylinder with each of at least two other birefringent bodies in contact on a side face of a circular cylinder with each other.

### TECHNICAL FIELD

The present invention relates to a liquid crystal display apparatus used as a display of a personal computer or the like, and to an optical member and reflective polarizer which are suitably applicable to such liquid crystal display apparatus.

### BACKGROUND ART

A liquid crystal display apparatus generally used at present includes a panel of a structure in which a nematic liquid crystal is provided between two transparent substrates to form a liquid crystal cell and in which polarizers are located on both sides of this cell. This panel is combined with an LSI for driving and a backlight to constitute a liquid crystal display apparatus. FIG. 1 is a schematic sectional view showing an example of the liquid crystal display apparatus. In this example, transparent electrodes 14, 15 are formed on one side of two transparent substrates 11, 12, respectively, the transparent electrodes are arranged to face each other, and a liquid crystal 17 is provided between them, thereby constituting a liquid crystal cell 10. Back polarizer 21 and front polarizer 22 are stuck to both sides of this liquid crystal cell 10, and a backlight 40 is placed on the back side of the back polarizer 21, thereby forming a liquid crystal display apparatus 50.

Incidentally, the liquid crystal display apparatus of this type does not always have a high efficiency of utilization of light emitted from the backlight because 50% or more of light emitted from the backlight 40 is absorbed by the back polarizer 21. As shown in FIG. 2, a reflective polarizer 45 is located between back polarizer 21 and backlight 40 in order to enhance the efficiency of utilization of the light from the backlight in the liquid crystal display apparatus. In FIG. 2, the reflective polarizer 45 is stuck to the back side of back polarizer 21 (around one side of backlight 40) in the liquid crystal display apparatus 50 shown in FIG. 1, and the other symbols are the same as those in FIG. 1, which are not described again to avoid repletion therein.

The reflective polarizer 45 reflects polarized light of a certain kind of polarization and transmits polarized light of another kind of polarization opposite thereto. The alignment therein is performed such that the light transmitted by the reflective polarizer 45 passes as linearly polarized light through the polarizer (normally, absorptive polarizer) 21. Then the polarizer 21 absorbs polarized light if only the polarizer 21 is used without the reflective polarizer 45, but the reflective polarizer 45 reflects polarized light to return the polarized light toward the backlight 40, as shown in FIG. 2, and to reuse the reflected light, thereby increasing the efficiency of utilization of the light emitted from the backlight 40.

The following documents for such reflective polarizers are known, which are listed as examples of the reflective polarizers: Japanese Patent Applications Laid-Open No. 6-281814 (Patent Document 1) and Laid-Open No. 8-271731 (Patent Document 2) describe reflective polarizers including a combination of a cholesteric liquid crystal layer with a quarter wave plate; Published Japanese translations of PCT applications No. P9-506837A (WO95/17303, Patent Document 3) and No. P10-511322A (WO96/19347, Patent Document 4) describe reflective polarizers including multilayered films of birefringent layers and isotropic layers; Published Japanese translation of a PCT application No. P2000-506990A (W097/32224, Patent Document 5) describe reflective polarizers including isotropic particle phases are dispersed in a birefringent continuous medium.

A reflective polarizer including a combination of a cholesteric liquid crystal layer with a quarter wave plate reflects left-handed (or right-handed) circularly polarized light, and transmits right-handed (or left-handed) circularly polarized light of a wavelength corresponding to the helical pitch of the cholesteric liquid crystal to convert it into linearly polarized light by use of the quarter wave plate. It is, however, difficult for this reflective polarizer to convert the right-handed (or left-handed) circularly polarized light from the cholesteric liquid crystal layer into linearly polarized light by the quarter wave plate of a single layer over the wavelength range of visible light. In order to overcome this difficultly, it is necessary to arrange a plurality of quarter wave plates to form the stacked quarter wave plates. Production steps for forming a stack of quarter wave plates become complicated and there will arise a problem that delamination of the quarter wave plates can occur.

A reflective polarizer of multilayered films that includes birefringent layers and isotropic layers alternately arranged requires formation of an alternate stack structure of several hundred layers and thus requires large-scale production facilities. The lamination of different materials can also pose a problem that delamination of the layers is likely to occur.

It is relatively easy to produce a reflective polarizer with isotropic particle phases in a birefringent continuous medium and the reflective polarizer is less likely to cause delamination of the layers. However, if the continuous medium is made of a uniaxially oriented substance demonstrating significant birefringence, increase in a volume fraction of the dispersed phases may result in failure in maintaining its film shape because of a reduction of its strength. For this reason, the volume fraction of the dispersed phases needs to be kept low, and it will pose a problem that it is difficult to enhance the polarization split efficiency.

Patent Document 1: Japanese Patent Application Laid-Open No. H06-281814

Patent Document 2: Japanese Patent Application Laid-Open No. H08-271731

Patent Document 3: Published Japanese translation of PCT application No. H09-506837A

Patent Document 4: Published Japanese translation of PCT application No. H10-511322A

Patent Document 5: Published Japanese translation of PCT application No. P2000-506990A

### DISCLOSURE OF THE INVENTION

Problem to be Solved by the Invention

In view of the foregoing problems, an object of the present invention is to provide a reflective polarizer capable of enhancing the efficiency of utilization of light in a liquid crystal display apparatus, relatively easy to produce, and unlikely to cause the problems such as the delamination.

Another object of the present invention is to provide an optical member capable of enhancing the efficiency of utilization of light in a liquid crystal display apparatus, based on a configuration wherein the reflective polarizer is laminated with an optical layer having another optical function.

Still another object of the present invention is to provide a liquid crystal display apparatus with an enhanced efficiency of utilization of light from a backlight, using the optical member with this reflective polarizer laminated.

Means for Solving the Problem

According to the present invention, a reflective polarizer comprises plural birefringent bodies of polygonal prisms or circular cylinders a shape of a cross section of which perpendicular to a major axis direction is polygonal or substantially circular, which has an aspect ratio of not less than 2, and which has a refractive index difference of not less than 0.05 between a refractive index component in a major axis direction and a refractive index component in a minor axis direction. The plural birefringent bodies are dispersedly arranged in a support medium substantially in one direction, and where the shape of the cross section perpendicular to the long axis direction of the birefringent bodies is substantially circular, any one of the plural birefringent bodies, when viewed on the cross section, is in contact on a side face of a circular cylinder with each of at least two other birefringent bodies in contact on a side face of a cylinder with each other.

In this reflective polarizer, the birefringent bodies dispersedly arranged in the support medium can be made of fibers a shape of a cross section of which perpendicular to the major axis direction thereof is polygonal. The fibers are preferably those having a sectional shape of a triangle, lengths of at least two sides of which are substantially equal to each other, and the fibers are so arranged that the fibers are substantially parallel in a plane of the reflective polarizer and that apexes of sectional triangles of adjacent fibers are in contact with each other; in a cross section in a thickness direction of the reflective polarizer perpendicular to the long axis of the fibers, the support medium surrounded by fibers of sectional triangles with their apexes in contact with each other is preferably of a hexagonal shape. This hexagonal shape can be substantially a regular hexagon. In this case, the above fibers dispersedly arranged in the support medium have the sectional shape of substantially a regular triangle, they are so arranged that they are substantially parallel in a plane of the reflective polarizer and that apexes of sectional regular triangles of adjacent fibers are in contact with each other, and in a cross section in the thickness direction of the reflective polarizer perpendicular to the long axis of the fibers, the support medium surrounded by fibers of sectional triangles with apexes in contact with each other is in a state of substantially a regular hexagon.

Another effective configuration is as follows: the above fibers dispersedly arranged in the support medium have the sectional shape of a triangle, lengths of at least two sides of which are substantially equal to each other. They are so arranged that they are substantially parallel in a plane of the reflective polarizer and that apexes of sectional triangles of adjacent fibers are in contact with each other, and in a cross section in the thickness direction of the reflective polarizer perpendicular to the long axis of the fibers, the support medium surrounded by fibers of sectional triangles with apexes in contact with each other is of a triangle. Lengths of two sides of the triangle are substantially equal to each other.

Furthermore, another effective configuration is as follows: the foregoing fibers dispersedly arranged in the support medium have a sectional shape of a quadrangle, lengths of four sides of which are substantially equal to each other. They are so arranged that they are substantially parallel in a plane of the reflective polarizer and that apexes of sectional quadrangles of adjacent fibers are in contact with each other, and in a cross section in the thickness direction of the reflective polarizer perpendicular to the long axis of the fibers, the support medium surrounded by fibers of sectional quadrangles with apexes in contact with each other is of a quadrangle. Lengths of four sides of the quadrangle are substantially equal to each other.

In this reflective polarizer, where the shape of the cross section perpendicular to the long axis direction of the birefringent bodies is substantially circular, a triangle defined by connecting centers of three circles in direct contact in the cross section perpendicular to the long axis direction of the birefringent bodies preferably has at least two sides which are substantially equal to each other. Among others, a preferable configuration is as follows: a triangle defined by connecting centers of three circles in direct contact in the cross section perpendicular to the long axis direction of the birefringent bodies has three sides which are substantially equal to each other. In this configuration, when the centers of the respective circles are connected in the cross section perpendicular to the long axis direction of three birefringent bodies in direct contact, the three sides of the triangle are substantially equal to each other, i.e., substantially a regular triangle, and this means that the diameters of the respective circles are substantially equal. Among others, in a preferred structure, circular cylinders, diameters of circles of which are substantially equal to each other, are close-packed. In another expression, the plural birefringent bodies in the preferred configuration are circular cylinders, the diameters of the circles of which are substantially equal to each other in the cross section perpendicular to the long axis direction, and in this cross section some of the birefringent bodies located in the inside of the outermost is in contact on a side face of a circular cylinder with other six birefringent bodies of circular cylinders. Each birefringent body in the reflective polarizer can be made of a fiber.

In the reflective polarizer in each of the above-described configurations, it is preferable that either one of the refractive index component of the birefringent bodies in the long axis direction and the refractive index component in the short axis direction is substantially equal to the refractive index of the support medium.

The reflective polarizer in each of these configurations can be provided on an optical layer with another optical function to form a laminated optical member. The optical layer to be laminated is, for example, an absorptive polarizer or a retardation plate. Furthermore, it is also possible to adopt a configuration in which an absorptive polarizer is provided on one surface of the reflective polarizer and a retardation plate is provided on the other surface.

The laminated optical member in each of these configurations can be combined with a liquid crystal cell to form a liquid crystal display apparatus. Therefore, the present invention also provides the liquid crystal display apparatus in which the laminated optical member in any one of the above configurations, which is a laminate of the reflective polarizer and another optical layer, is placed on the liquid crystal cell.

Effect of the Invention

The reflective polarizer of the present invention has a structure in which the birefringent bodies are dispersed and oriented substantially in one direction, by the simple method, and is resistant to delamination because the interface between different materials is not a simple plane. Since the support medium for supporting the birefringent bodies is made of the isotropic substance, the reduction of its strength is relatively small with increase in the volume fraction of the birefringent bodies, and it is thus easy to increase the volume fraction of the birefringent bodies. Furthermore, by locating this reflective polarizer on the opposite side to an observer of the liquid crystal panel with the absorptive polarizer, it becomes feasible to provide the liquid crystal display apparatus capable of achieving high luminance and low power consumption because the efficiency of utilization of light is increased.

### BRIEF DESCRIPTION OF THE DRAWINGS

FIG. 1 is a schematic sectional view showing an example of a conventional liquid crystal display apparatus.

FIG. 2 is a schematic sectional view showing an example of a reflective polarizer provided in the liquid crystal display apparatus of FIG. 1 to enhance the efficiency of utilization of light from a backlight.

FIG. 3 is a schematic view showing an example of a cross section of reflective polarizer according to an embodiment of the present invention in a thickness direction parallel to its transmission axis.

FIG. 4 is a schematic sectional view showing another example of a reflective polarizer according to an embodiment of the present invention.

FIG. 5 is a schematic sectional view showing still another example of a reflective polarizer according to an embodiment of the present invention.

FIG. 6 is a schematic sectional view showing yet another example of a reflective polarizer according to an embodiment of the present invention.

FIG. 7 is a schematic sectional view showing yet another example of a reflective polarizer according to an embodiment of the present invention.

FIG. 8 is a schematic sectional view showing yet another example of a reflective polarizer according to an embodiment of the present invention.

FIG. 9 includes part (a), which is an enlargement of a part of FIG. 7, schematically showing a relationship of triangles formed by connecting centers of circles adjacent to each circle, and part (b), which is an enlargement of a part of FIG. 8, schematically showing a relation of triangles formed by connecting centers of circles adjacent to each circle.

FIG. 10 is a schematic sectional view showing an example of a laminated optical member according to an embodiment of the present invention.

FIG. 11 is a schematic sectional view showing an example of a liquid crystal display apparatus according to an embodiment of the present invention.

FIG. 12 includes part (a), part (b), and part (c) showing schematic views of a system used in calculation in Example 1.

FIG. 13 includes part (a), part (b), and part. (c) showing schematic views of a system used in calculation in Example 2.

FIG. 14 includes part (a), part (b), and part (c) showing schematic views of a system used in calculation in Example 3.

FIG. 15 includes part (a), part (b), and part (c) showing schematic views of a system used in calculation in Example 4.

FIG. 16 includes part (a), part (b), and part (c) showing schematic views of a system used in calculation in Example 5.

FIG. 17 includes part (a), part (b), and part (c) showing schematic views a system used in calculation in Example 6.

FIG. 18 includes part (a), part (b), and part (c) showing schematic views of a system used in calculation in Comparative Example 1.

### DESCRIPTION OF REFERENCE SYMBOLS

10 liquid crystal cell;

11, 12 transparent substrate;

14, 15 transparent electrode;

17 liquid crystal;

21, 22 absorptive polarizer;

25 retardation plate;

30 reflective polarizer;

31, 32 birefringent body;

33 support medium;

35 laminated optical member;

40 backlight device;

45 reflective polarizer (conventional);

50 liquid crystal display apparatus.

### BEST MODES FOR CARRYING OUT THE INVENTION

For describing the best mode for the present invention, the following embodiments will be separately described a shape of the cross section perpendicular to the long axis direction of the birefringent bodies dispersedly arranged in the support medium is polygonal; and the shape of the section is substantially circular. In subsequent embodiments, the two cases will be described together.

<The case where the shape of the cross section perpendicular to the long axis direction of the birefringent bodies dispersedly arranged in the support medium is polygonal>

In an embodiment of the present invention, the birefringent bodies are dispersedly arranged in the support medium to form the reflective polarizer. Each birefringent body has the sectional shape of a polygon and the aspect ratio of not less than 2. Here the aspect ratio is preferably not less than 5 and more preferably not less than 10. The aspect ratio is defined as a ratio of a length to a short-axis diameter, but, since the embodiment of the present invention uses the birefringent bodies each having the sectional shape of the polygon, the short-axis diameter is defined as a diameter of a circumscribed circle to the polygon. When each birefringent body has the cross section of the polygonal shape and is elongate or longitudinal and when the refractive index is properly selected, the polarizer reflects light linearly polarized in the direction parallel to the elongate direction and transmits light linearly polarized in the direction perpendicular to the major direction.

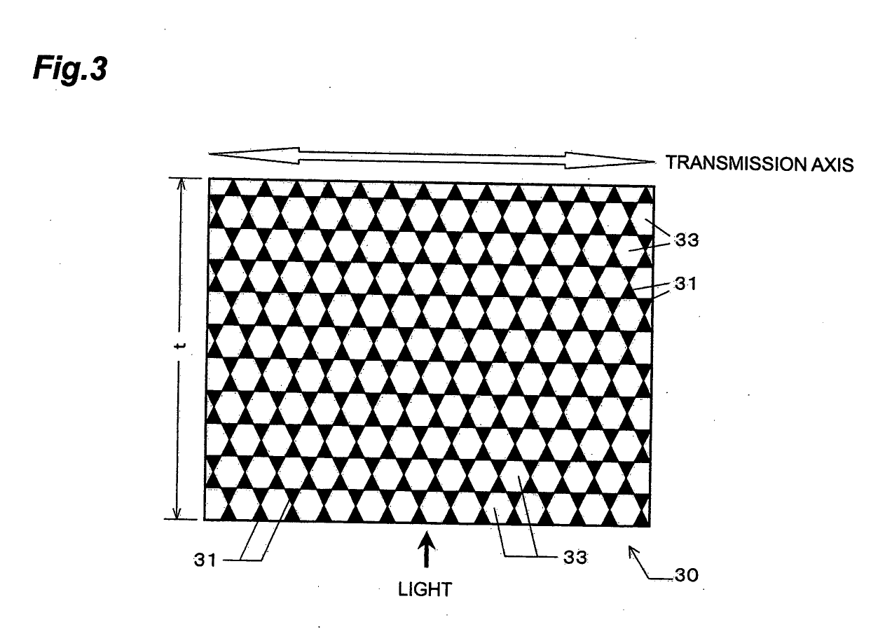

Specific examples of the sectional structure of the reflective polarizer according to the embodiment of the present invention are presented in FIGS. 3 to 6. These examples schematically show the cross section taken in the direction of thickness, parallel to the transmission axis indicated by an outline two-headed arrow, of the reflective polarizer. In the reflective polarizer 30 of the present invention, as shown in these drawings, birefringent bodies 31 with the sectional shape of a polygon (blackened portions) are dispersedly arranged in the support medium 33 (white portions).

FIG. 3 is a schematic view showing an example of the cross section in the thickness direction parallel to the transmission axis of the reflective polarizer according to the embodiment of the present invention; in this example, in the cross section taken in the thickness direction parallel to the transmission axis of the reflective polarizer 30, birefringent bodies 31, having the sectional shape of a triangle with two sides substantially equal to each other in length are so arranged that the bodies 31 are substantially parallel to each other in the plane of the reflective polarizer 30 and apexes of sectional triangles of adjacent birefringent bodies 31 are in contact with each other, and in this cross section the support medium 33 is surrounded by birefringent bodies 31 corresponding to sectional triangles with their apexes that are in contact with each other, and is of a hexagonal shape.

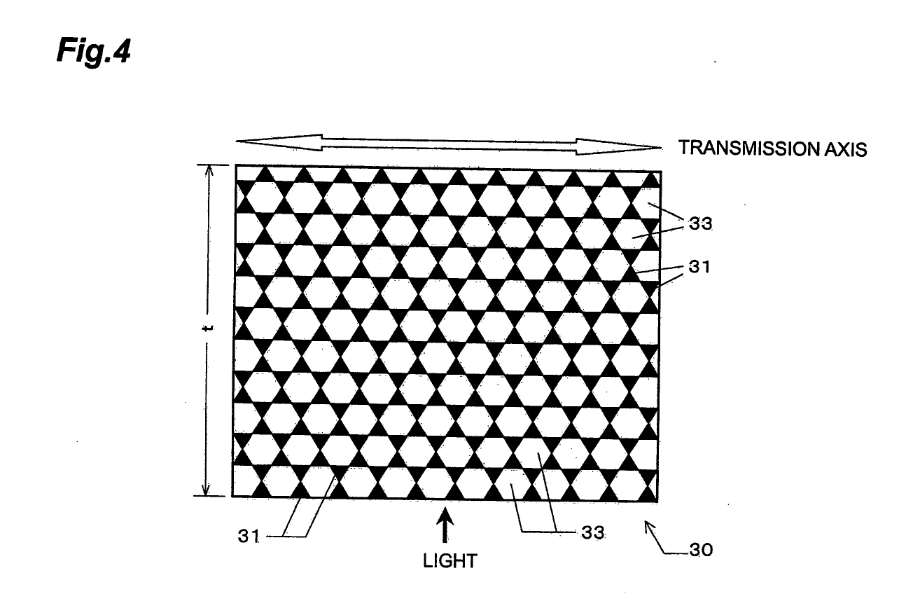

FIG. 4 is a schematic sectional view showing another example of the reflective polarizer according to the embodiment of the present invention; in this example, in the cross section in the thickness direction parallel to the transmission axis of the reflective polarizer 30, birefringent bodies 31, having the sectional shape of a triangle with the three sides substantially equal to each other (i.e., substantially a regular triangle), are so arranged that the bodies 31 are substantially parallel in the plane of the reflective polarizer 30 and apexes of sectional triangles of birefringent bodies 31 adjacent to each other are in contact with each other, and in this cross section, the support medium 33 is surrounded by birefringent bodies 31 corresponding to sectional triangles with their apexes that is in contact with each other, and is substantially of a regular hexagon.

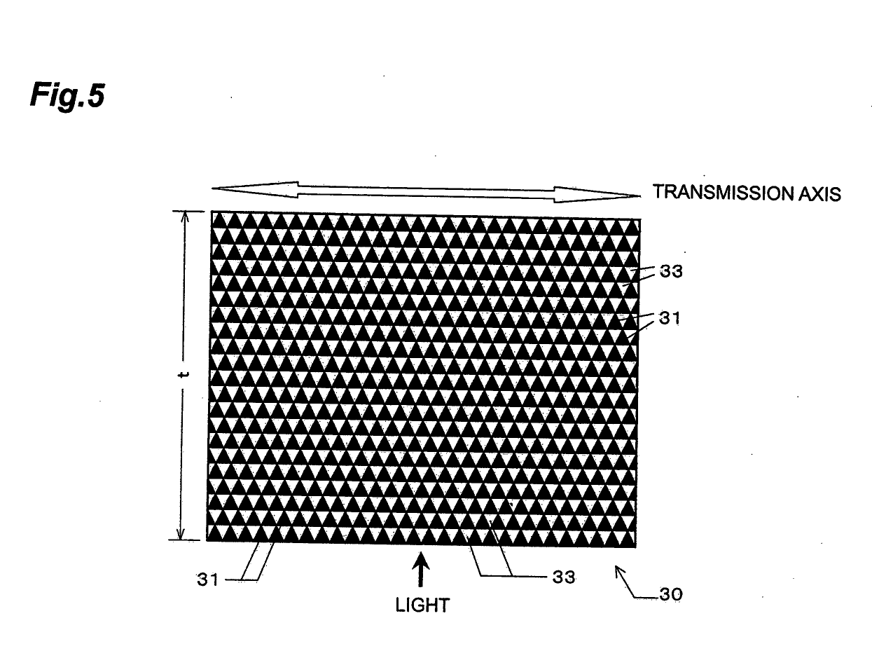

FIG. 5 is a schematic sectional view showing still another example of the reflective polarizer according to the embodiment of the present invention. In this example, in the cross section taken in the thickness direction parallel to the transmission axis of reflective polarizer 30, birefringent bodies 31 having the sectional shape of a triangle with substantially equal two sides are so arranged that the bodies 31 are substantially parallel to each other in the plane of the reflective polarizer 30 and that apexes of sectional triangles of birefringent bodies 31 adjacent to each other are in contact with each other, and in this cross section, the support medium 33 is surrounded by birefringent bodies 31 corresponding to the sectional triangles with their apexes that are in contact with each other, and is of a triangle two sides of which are substantially equal to each other.

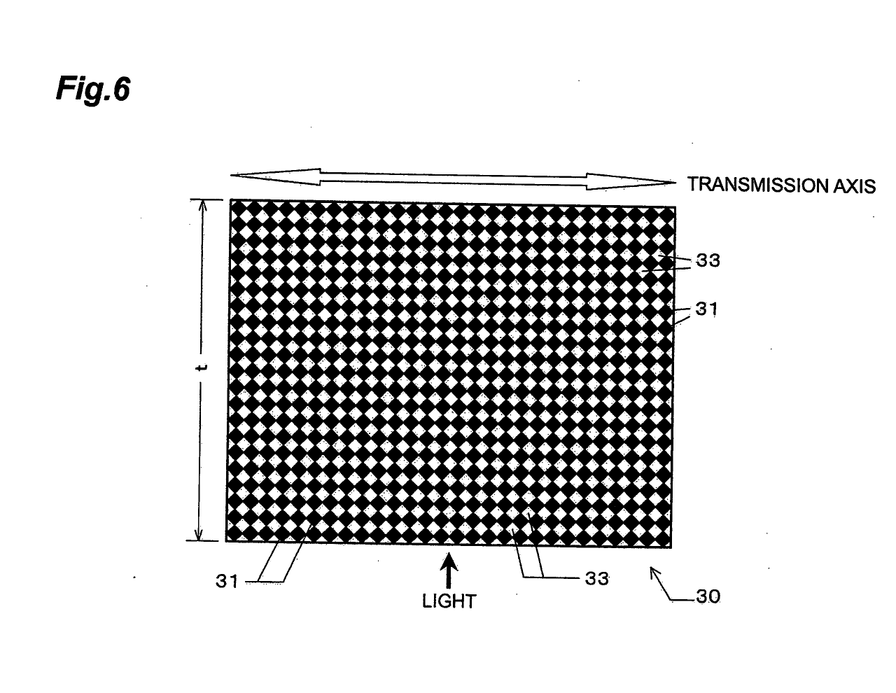

FIG. 6 is a schematic sectional view showing still another example of the reflective polarizer according to the embodiment of the present invention; in this example, in the cross section taken in the thickness direction parallel to the transmission axis of the reflective polarizer 30, birefringent bodies 31 have the sectional shape of a quadrangle with the four sides substantially equal to each other and are so arranged that the bodies 31 are substantially parallel in the plane of the reflective polarizer 30 and that apexes of sectional quadrangles of adjacent birefringent bodies 31 are in contact with each other, and in this cross section, the support medium 33 is surrounded by birefringent bodies 31 of sectional quadrangles with apexes that are in contact with each other and is of a quadrangle the four sides of which are substantially equal to each other.

In FIGS. 3 to 6, the thickness of the reflective polarizer 30 is indicated by symbol “t”. The examples shown in FIGS. 3 and 4 can be described in another expression s follows: the triangles in the cross section of the birefringent bodies 31 are stacked in the thickness direction in the cross section taken along the thickness direction parallel to the transmission axis of the reflective polarizer 30 and the triangles are alternately orientated to different directions. On the other hand, the example shown in FIG. 5 can be described as follows: in the cross section along the thickness direction parallel to the transmission axis of the reflective polarizer 30, the triangles in the cross section of the birefringent bodies 31 are orientated to in the same direction and are stacked in the thickness direction. The example shown in FIG. 6 can be described as follows: in the thickness direction in the cross section along the thickness direction parallel to the transmission axis of the reflective polarizer 30, the quadrangles in the cross section of the birefringent bodies 31 are stacked and are orientated to the same direction.

In the present specification, the triangle the lengths of at least two sides of which are substantially equal is a conception encompassing substantially isosceles triangles and substantially regular triangles, and the quadrangle the lengths of the four sides of which are substantially equal is a conception encompassing substantially rhomboids and substantially squares. Furthermore, the term “substantially equal” for two sides, three sides, or four sides encompasses cases where the lengths of the sides are completely equal, and also means that some variation is allowed from approximately +10% to approximately −10% (approximately ±10%) of the length of one side to another side. Yet furthermore, the term “substantially” in “substantially isosceles triangles,” “substantially regular triangles,” “substantially regular hexagons,” “substantially rhomboids,” and “substantially squares” means that some variation is allowed from approximately +10° to approximately −10° (approximately ±10°) for angles of apexes primarily in the case of the polygonal shapes (in the case of an isosceles triangle, two angles that should be originally equal). The polygonal shapes are based on the assumption that each side of the relevant polygon is a straight line, but in manufactured fibers, each side become curved to some extent. Therefore, this shade of meaning is expressed by the term “substantially.” In addition, in the cases where the term “substantially” is given for expression of angles, it means that some variation is allowed from approximately +10° to approximately −10° (approximately ±10°) around an angle expressed.

The birefringent bodies 31 can be constructed of fibers. The support medium 33 may be made of material that is transparent and demonstrates good adhesion to the birefringent bodies 31. The birefringent bodies 31 have the sectional shape of a polygon and among others, they preferably have the sectional shape of a triangle with at least two sides thereof substantially equal to each other, a quadrangle with the four sides thereof substantially equal to each other, or substantially a regular polygon and preferably have the sectional shape of substantially a regular triangle. The length of each side of the polygon needs to be larger than the wavelengths of visible light and is preferably not less than 1 micrometer (μm) and more preferably not less than 5 micrometers (μm). If the length of each side of the polygon is less than 1 micrometer (μm), good polarization separation performance will not be achieved. The birefringent bodies 31 need to have the refractive index difference of not less than 0.05 between the refractive index in the long axis direction (the direction of the length of the birefringent bodies) and the refractive index in the short axis direction (the direction of the diameter of the polygon), and this refractive index difference is preferably not less than 0.1 and more preferably not less than 0.2.

In the embodiment of the present invention, the birefringent bodies 31 are dispersedly oriented in the support medium 33 to form the reflective polarizer 30 of a structure and, in one preferable structure of the birefringent bodies 31, are substantially oriented in one direction and in more preferably, the birefringent bodies 31 are closely packed. Among others, in a preferred configuration, the birefringent bodies 31 having the sectional shape of a regular triangle are so arranged that they are substantially parallel in the plane and that apexes of sectional regular triangles of adjacent birefringent bodies 31 are in contact with each other, as shown in FIG. 4. Preferably, in the cross section take in the thickness direction of the reflective polarizer perpendicular to the long axis of the birefringent bodies 31, the support medium 33 is surrounded by the birefringent bodies 31 of the sectional triangles with the apexes that are in contact with each other, and is substantially a regular hexagon. In the structures as shown in FIGS. 3 to 5, each apex of a triangle may have some deviation within approximately a half of the length of each side in the vertical, horizontal, and oblique directions. In the structure as shown in FIG. 6, similarly, each apex of a quadrangle may have some deviation within approximately a half of the length of each side in the vertical, horizontal, and oblique directions.

If parallel light is normally incident to the plane of the reflective polarizer 30 and the diameter is at a level that does not need for consideration to scattering factors, relatively high polarization separation performance can be obtained in the flowing cases even when the number of layers of the birefringent bodies 31 in the thickness direction of the reflective polarizer 30 may be one; the birefringent bodies 31 having the sectional shape of an isosceles triangle or a regular triangle are arranged in the thickness direction so as to alternately stack the triangles of two types, one orientation of which is different from the other, such that the birefringent bodies 31 are substantially parallel in the plane and that apexes of sectional triangles of adjacent birefringent bodies 31 are in contact with each other, as shown in FIGS. 3 and 4; and the birefringent bodies 31 having the sectional shape of a triangle or a quadrangle are arranged substantially parallel in the plane and are stacked in the same orientation in the thickness direction, as shown in FIGS. 5 and 6. Therefore, the number of layers may be arbitrarily selected in the range from approximately 1 to 100. It is, however, difficult in practice to make perfectly parallel light incident, and thus, preferably, the number of the layers should be plural; for example, the number of the layers is preferably not less than 3 and further preferably not less than 5. In the examples shown in FIGS. 3 to 6, the birefringent bodies 31 have about twenty one layers stacked in the thickness direction. In FIGS. 3 and 4, if the support medium 33 has the cross section of the hexagon, the number of the stacked layers is about 10.5 layers.

<The case where the shape of the cross section perpendicular to the long axis direction of the birefringent bodies dispersedly arranged in the support medium is substantially circular>

In the embodiment of the present invention, the birefringent bodies are dispersedly arranged in the support medium to form the reflective polarizer. The birefringent bodies have longitudinal shapes, the shape of the cross section perpendicular to the long axis direction thereof is substantially a circle, and the aspect ratio is not less than 2. Here the aspect ratio is preferably not less than 5 and more preferably not less than 10. The aspect ratio is represented by a ratio of a length to a short-axis diameter. Since the present invention adopts the birefringent bodies of cylinders having the sectional shape of substantially a circle, the diameter of the circle corresponds to the short-axis diameter. If a polarizer is constructed using the birefringent bodies in the shape of the longitudinal cylinder having the cross section of substantially a circle, the birefringent bodies are closely packed and the refractive index of the birefringent bodies is properly selected, then this polarizer reflects light linearly polarized in the direction parallel to the longitudinal direction and transmits light linearly polarized in the direction perpendicular to the longitudinal direction.

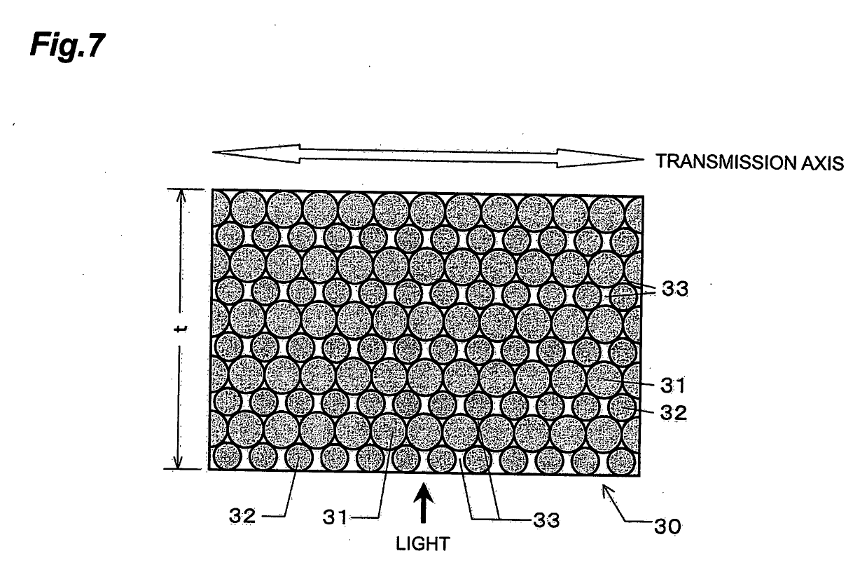

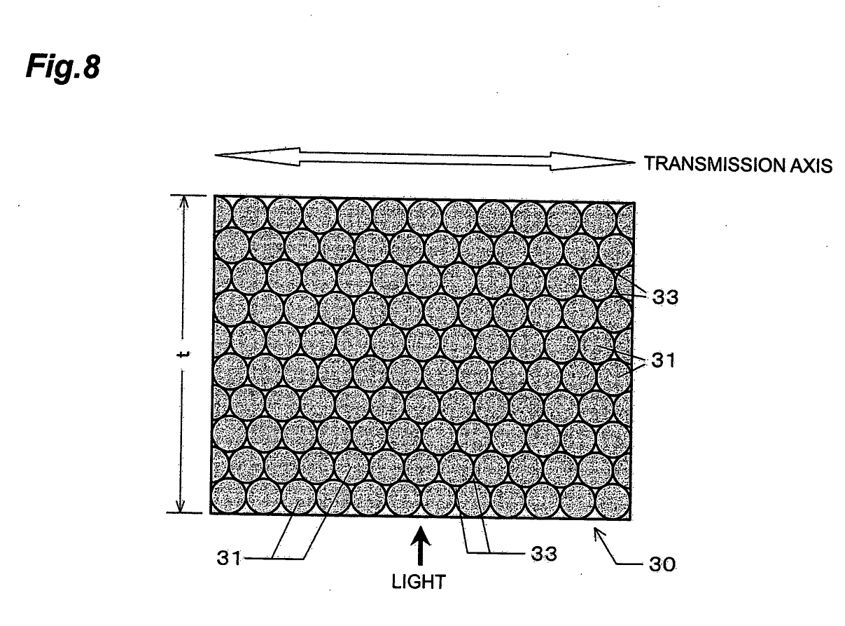

Specific examples of the sectional structure of the reflective polarizer according to the embodiment of the present invention are shown in FIGS. 7 and 8. These examples schematically show the cross section in the thickness direction parallel to the transmission axis indicated by an outline two-headed arrow of the reflective polarizer. As shown in these drawings, the reflective polarizer 30 of the embodiment of the present invention has birefringent bodies 31, 32 having the sectional shape of substantially a circle (bodies 31 in FIG. 8; lightly shaded circular and semicircular portions) dispersedly arranged in the support medium 33 (portions surrounded by circles or semicircles which are in contact with each other). In these drawings, the thickness of the reflective polarizer 30 is indicated by symbol “t”

FIG. 7 is a view schematically showing the cross section, taken in the thickness direction parallel to the transmission axis, of an example of the reflective polarizer in the embodiment of the present invention. In this example, in the cross section taken along the thickness direction parallel to the transmission axis of the reflective polarizer 30, the birefringent bodies 31, 32 including two types of circular cylinders having diameters different from each other are dispersedly arranged substantially in parallel in the plane of the reflective polarizer 30 and in the direction perpendicular to the transmission axis. Any one of the birefringent bodies 31, 32 with the cross section of substantially a circle, when viewed on the cross section, is in contact on the side face of the circular cylinder (the circumference in the sectional view) with each of at least two other birefringent bodies in contact on the side face of the circular cylinder (the circumference in the sectional view) with each other. In this example, the circular cylinders 31 with a relatively large diameter are closely arranged in this cross section in a line in a transverse direction, and the circular cylinders 32 with a relatively small diameter are arranged so that each of cylinders 32 is in contact with two adjacent circular cylinders 31 with the relatively large diameter on the transverse line, thereby forming a structure in which lines of the cylinders of the relatively large diameter and lines of the cylinders of the relatively small diameter are stacked in a total often layers.

FIG. 8 is a schematic sectional view showing another example of the reflective polarizer according to the embodiment of the present invention. In this example, the birefringent bodies 31 are constituted by cylinders in which diameters of circles in the cross section taken in the thickness direction parallel to the transmission axis of the reflective polarizer 30 are substantially equal to each other, and are dispersedly arranged substantially in parallel in the plane of the reflective polarizer 30 and in the direction perpendicular to the transmission axis. Any one of the birefringent bodies 31 with the cross section of substantially a circle, when viewed on this cross section, is in contact on the side face of the circular cylinder (the circumference in the sectional view) with each of at least two other birefringent bodies in contact on the side face of the circular cylinder (the circumference in the sectional view) with each other. In this example, the circular cylinders with substantially an equal diameter are alternately arranged in contact, thereby forming a structure in which they are stacked in a total of ten layers.

In the embodiment of the present invention, the birefringent bodies 31, 32 have substantially circular shapes in the cross section perpendicular to the long axis direction. Here the term “substantially circular shape” means that the foregoing ellipticity can be tolerated within approximately 0.9-1.1 (1±10.1) because the birefringent bodies can be slightly elliptic because of its manufacturing variation, and although the term is thus used in such cases, the tern indicates preferably a perfect circle, i.e., the ellipticity defined by a ratio of a major axis of an ellipse to a minor axis thereof is preferably 1.

The birefringent bodies 31, 32 are dispersedly arranged in a substantially identical direction in the support medium 33. The term “substantially identical direction” means that some variation is allowed in the angular range of approximately −10° to +10° both inclusive (±10°) and preferably the birefringent bodies are arranged in a perfectly identical direction. In addition, the phrase “lengths are substantially equal” means that some variation is allowed from approximately +10% to approximately −10% (±10%), and preferably they are perfectly equal.

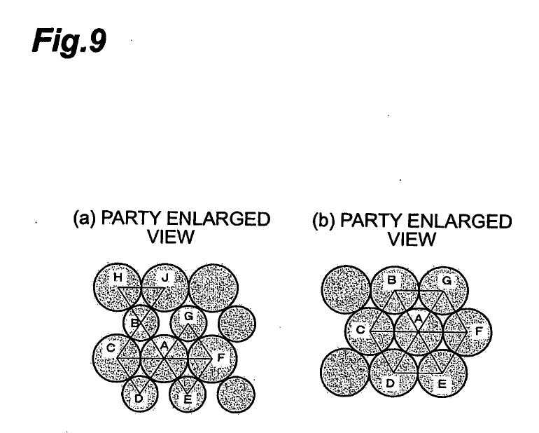

Furthermore, in the embodiment of the present invention, a plurality of birefringent bodies having the sectional shape of substantially a circle perpendicular to the long axis direction are dispersedly arranged so that, in a cross section thereof, the side face of the circular cylinder (the circumference in the sectional view) of any one of the birefringent bodies is in contact with those of at least two other birefringent bodies that are in contact on the side face of the circular cylinder thereof (the circumference in the sectional view) with each other. When attention is focused to a certain circle in the cross section perpendicular to the long axis direction of the birefringent bodies, the state in which the circle is in contact on the side face of the circular cylinder (the circumference in the sectional view) with each of at least two other birefringent bodies in contact on the side face of the circular cylinder (the circumference in the sectional view) with each other corresponds to a state in which, concerning the relevant circle and two other circles in contact therewith, a length of a side of a triangle composed of three apexes on the centers of these circles is the sum of radii of respective circles centered on a start point and an end point of the side. This will be described on the basis of FIG. 5 showing enlarged parts of FIG. 3 and FIG. 4. In FIG. 9, part (a) is a partly enlarged view of FIG. 7, and part (b) a partly enlarged view of FIG. 8.

Referring to part (a) in FIG. 9 showing the partly enlarged view of FIG. 7 and, let us focus our attention to one cylinder “A” of the circular cylinders with the relatively large diameter (circles in the sectional view). This circle “A” is in contact with the following: each of circle “B” and circle “C” adjacent to each other on the side face of these circular cylinder (the circumference in the sectional view); each of circle “C” and circle “D” adjacent to each other on the side face of these circular cylinder (the circumference in the sectional view); each of circle “E” and circle “F” adjacent to each other on the side face of these circular cylinder (the circumference in the sectional view); each of circle “F” and circle “G” adjacent to each other on the side face of these circular cylinder (the circumference in the sectional view). On the other hand, let us focus our attention to one cylinder “B” of the circular cylinders with the relatively small diameter (circles in the sectional view). This circle “B” is in contact with the following: each of circle “A” and circle “C” adjacent to each other on the side face of these circular cylinder (the circumference in the sectional view); and each of circle “H” and circle “J” adjacent to each other on the side face of these circular cylinder (the circumference in the sectional view). In this example, however, the circles with the relatively small diameter are not in contact with each other. In this example, a triangle formed by connecting centers of three circles arranged in direct contact with each other is an isosceles triangle, i.e., a triangle of two sides of which are equal to each other in length.

Referring to part (b) in FIG. 9 showing the partly enlarged view of FIG. 8, in this case, a plurality of circular cylinders with the substantially equal diameter are arranged in one direction in contact with each other. Let us focus our attention to a certain circle “A”. This circle “A” is in contact with each of circle “B” and circle “C” adjacent to each other on the side face of the circular cylinder (the circumference in the sectional view). Furthermore, the circle “A” is is similarly in contact with the following circles: two circles “C” and “D”; two circles “D” and “E”; two circles “E” and “F”; two circles “F” and “G”; and two circles “G” and “B.” Thus, the circle “A” is in contact with a total of six circles. If we focus our attention to the another circle, the same arrangement applies to the other circles on the basis of the other circle. It is, however, noted that each of circles located in the outermost layer in the reflective polarizer 30 in FIG. 8 is in contact with only four circles. In this example, a triangle defined by connecting centers of three circles in direct contact with each other is a regular triangle, i.e., a triangle with equal three sides.

It is understood from the above description that a variety of modifications can be made, in addition to the examples shown in FIGS. 7 and 8. For example, in a case where three types o r more types of circular cylinders with diameters different from each other are arranged, a triangle defined by connecting centers of three circles in contact with each other in the cross section perpendicular to the long axis direction thereof is an inequilateral triangle. FIGS. 7 and 8 show the configurations in which the circular cylinders are arranged in the cross section perpendicular to the long axis direction of the birefringent bodies (circular cylinders) so that the circles in the first layer are in contact with the circles in the second layer, circles in the second layer in contact with the circles in the third layer, and circles in the subsequent layer in contact with those in a next layer, and the individual birefringent bodies satisfy a condition that each birefringent body is “in contact on the side face of the circular cylinder with each of at least two other birefringent bodies in contact on the side face of the circular cylinder with each other.” Under this condition, the following arrangement can be made: circles in the first layer are in contact with the circles in the second layer; circles in the second layer and the circles in the third layer are separated from each other through the support medium; and circles in the third layer are again in contact with the circles in the fourth layer. If a plurality of circular cylinders are dispersedly arranged and are separated from each other, good polarization separation performance cannot be achieved as in a comparative example that will be described later.

A triangle formed by connecting centers of three circles that are in direct contact with each other in the cross section perpendicular to the long axis direction of the birefringent bodies is preferably a triangle at least two sides of which are substantially equal, and among others, preferably, this triangle has three sides which are substantially equal to each other. The birefringent bodies in the thickness direction of the reflective polarizer is preferably stacked in an arrangement in which a plurality of layers are stacked in contact successively, and more preferably is stacked in an arrangement in which the birefringent bodies constituted by circular cylinders each having a substantially equal diameter are closely packed. In the more preferred configuration, accordingly, the plurality of birefringent bodies 31 are formed as the circular cylinders in which circles in the cross section perpendicular to the long axis direction have diameters substantially equal to each other, and, as shown in FIG. 8 and in part (b) in FIG. 9, each of the birefringent bodies located in a medial region to the outermost layer in the cross section is in contact on the side face of the circular cylinder with six other birefringent bodies of circular cylinders.

The birefringent bodies 31, 32 as shown in FIG. 7 and the birefringent bodies 31 as shown in FIG. 8 can be constructed of fibers. The support medium 33 may be made of material that is transparent and demonstrates good adhesion to the birefringent bodies 31, 32. The sectional shape of the birefringent bodies 31, 32 are substantially a circle, and the diameter of the circle needs to be larger than the wavelengths of visible light and is preferably not less than 1 micrometer (μm) and more preferably not less than 5 micrometers (μm). If the diameter of the circle is less than 1 micrometer (μm), good polarization separation performance cannot be achieved. The birefringent bodies 31, 32 need to have a refractive index difference of not less than 0.05 between the refractive index in the long axis direction (the direction of the length of the birefringent bodies) and the refractive index in the short axis direction (the direction of the diameter of the circle), and this refractive index difference is preferably not less than 0.1 and more preferably not less than 0.2.

As shown in FIG. 8 and in part (b) in FIG. 9, in the case where the birefringent bodies 31 of the circular cylinders with substantially the same diameter are close-packed, if light is normally incident to the plane of the reflective polarizer 30, relatively high polarization separation performance can be obtained by arranging a single layer of the birefringent bodies 31 in the thickness direction of the reflective polarizer 30. On the other hand, in order to satisfy the condition that any one of the birefringent bodies as defined in the present invention, when viewed on the cross section perpendicular to the long axis direction of the birefringent bodies, is in contact on the side face of the circular cylinder with each of at least two other birefringent bodies in contact on the side face of the circular cylinder with each other, at least two layers are necessary. Since perfectly parallel light incident thereon is not easily obtained, the number of layers of the birefringent bodies 31, 32 in the thickness direction of the reflective polarizer 30 is selected, for example, in the range of approximately 2 to 100 and preferably approximately 5 to 100, in the following cases: the birefringent bodies 31, 32 of the circular cylinders with different diameters are combined as shown in FIG. 7; and the birefringent bodies 31 of the circular cylinders with substantially the same diameter are arranged as shown in FIG. 8.

In the reflective polarizer 30 constructed as shown in FIGS. 3, 4, 7, and 8, the birefringent bodies 31, 32 are oriented substantially in one direction in the polarizer, in either of the case where the shape of the cross section perpendicular to the long axis direction of the birefringent bodies dispersedly arranged in the support medium is polygonal and the case where the sectional shape is substantially circular. Either one of the refractive index in the long axis direction and the refractive index in the short axis direction of the birefringent bodies 31, 32 is preferably made substantially equal to the refractive index of the support medium 33. In this case, since the birefringent bodies 31 and 32 exhibit birefringence, the other of the refractive indices is not equal to the refractive index of the support medium 33. Particularly, where fibers are used as the birefringent bodies 31, 32, it is preferable that the refractive index in the short axis direction thereof (in the case where the birefringent bodies are polygonal, the short axis direction is the direction of the diameter of the polygon; in the case where the birefringent bodies are circular, the short axis direction is the direction of the diameter of the circle) is made equal to the refractive index of the support medium 33 and that the refractive index in the major direction of the fibers is not coincident with the refractive index of the support medium 33. This arrangement results in transmitting light linearly polarized in the diction in which the refractive indices of the birefringent bodies 31, 32 and the support medium 33 are equal to each other and, at the interface between the birefringent bodies 31 and the support medium 33, reflecting light linearly polarized in the direction in which the refractive indices of the birefringent bodies 31, 32 and the support medium 33 are not equal to each other, thus exhibiting polarization separation performance.

In principle, although a variety of substances demonstrating birefringence as the birefringent bodies 31, 32 can be used for the present invention, in terms of stability, endurance, etc. of orientation and sectional shape, the birefringent bodies 31, 32 are preferably solid.

Furthermore, the birefringent bodies 31, 32 can be made of a substance in the sectional shape of a polygon and in an aspect ratio of not less than 2. Among substances meeting this condition, the most preferred is continuous fibers for the birefringent bodies 31, 32 because they can be readily highly oriented in the support medium 33 and effectively demonstrate birefringence.

The fibers used for the birefringent bodies 31, 32 will be described below. Examples of such fibers are listed as follows: polyolefin-vinyl fibers such as polyethylene, polytetrafluoroethylene, polypropylene, polyvinyl alcohol, polyvinyl chloride, polyacrylonitrile, and poly(4-methyl-1-pentene); aliphatic polyamide fibers such as nylon 6, nylon 66, and nylon 46; aromatic polyamide fibers (aramid fibers) such as poly(m-phenylene isophthal amide) and poly(p-phenylene terephthal amide); polyester fibers such as polyethylene terephthalate, polyethylene naphthalate, and poly-ε-caprolactone; aromatic liquid crystal polyester fibers typified by “VECTRA” commercially available from Polyplastics Co., Ltd., and “Sumika Super” commercially available from Sumitomo Chemical Co., Ltd.; heteroatom-containing fibers such as poly(p-phenylene-benzo-bis-oxazole), poly(p-phenylene-benzo-bis-thiazole), polybenzimidazole, polyphenylene sulfide, polysulfone, poly(ether sulfone), and poly(ether ether ketone); polyimide fibers such as polypyromellitic imide; cellulose fibers such as rayon; acrylic fibers such as poly(methyl methacrylate); polycarbonate fibers; urethane fibers, and so on. Among these, it is particularly preferable to use as the birefringent bodies, fibers that have an aromatic ring such as a benzene ring or a naphthalene ring, and that have little or no absorption in the visible light region.

In order to enhance the adhesion to the support medium, the fiber surface may be subjected to any of various adhesion-enhancing treatments such as the corona treatment. Furthermore, useful techniques for enhancing the birefringence of fibers are to add whiskers of low-molecular-weight liquid crystal compounds, fillers with shape anisotropy, or the like, to adopt the SAM fiber (Super-summational, Axially arranged & Mutual-polymers-configuration-type composite fiber) of a multifilament type

Examples of the low-molecular-weight liquid crystal compounds to be added to the fibers in order to enhance the birefringence include compounds having as a mesogen (a core unit to develop the liquid crystal property in a molecular structure) a compound selected from biphenyl-based, phenyl benzoate-based, cyclohexyl benzene-based, azoxybenzene-based, azobenzene-based, azomethine-based, terphenyl-based, biphenyl benzoate-based, cyclohexyl biphenyl-based, phenyl pyrimidine-based, cyclohexyl pyrimidine-based, and cholesterol-based compounds. These low-molecular-weight liquid crystal compounds may be dissolved in the fibers or may exist as domains as long as they are oriented in the long axis direction of the fibers. However, where they exist as domains, the diameter of the domains is preferably not more than 0.2 micrometer (0.2 μm). The diameters of the domains larger than 0.2 micrometer (0.2 μm) are not preferred because they scatter linearly polarized light vibrating in the direction perpendicular to the long axis of fibers.

Examples of the whiskers to be added to the fibers in order to enhance the birefringence include sapphire, silicon carbide, boron carbide, silicon nitride, boron nitride, aluminum borate, graphite, potassium titanate, polyoxymethylene, poly(p-oxybenzoyl), poly(2-oxy-6-naphthoyl), and so on. These whiskers are preferably those having the average diameter of the cross section thereof in the range of 0.05 to 0.2 micrometer (0.05-0.2 μ). The average diameters larger than 0.2 micrometer (0.2 μm) are not preferred because they scatter linearly polarized light vibrating in the direction perpendicular to the long axis of the fibers, just as in the case of the low-molecular-weight liquid crystal compounds, and because the whiskers can form projections on the surface of the fibers.

When the SAM fibers are used as the birefringent bodies 31, 32, the SAM fibers are in a state in which islands are dispersedly arranged in a sea. In this case, either one of the refractive index in the long axis direction and the refractive index in the short axis direction of the islands is preferably made substantially coincident with the refractive index of the sea. In this case, the diameter of the islands is also preferably not more than 0.2 micrometer (0.2 μm). Preferably, two or more islands exist in the sea and, more preferably, four or more islands exist in the sea. A filler with shape anisotropy, such as a low-molecular-weight liquid crystal or a whisker, may be further added to the islands.

In the embodiment of the present invention as described above, the birefringent bodies 31 having the polygonal cross section and the aspect ratio of not less than 2 or the birefringent bodies 31, 32 having the sectional shape of substantially a circle and the aspect ratio of not less than 2, e.g., fibers, are dispersedly arranged in the support medium 33. The support medium 33 functions to fix the birefringent bodies 31, 32. The support medium may be any material that has little absorption or no absorption in the visible light region and that demonstrates good adhesion to the fibers. For example, the support medium can be a transparent resin. Specific examples of the transparent resin include acrylic resins such as poly (methyl methacrylate); polyolefins such as polyethylene; polyesters such as polyethylene terephthalate; polyethers such as polyphenylene oxide; vinyl resins such as polyvinyl alcohol; polyurethane; polyamide; polyimide; epoxy resin; copolymers using two or more monomers constituting the foregoing polymers; non-birefringent polymer blends such as a mixture of poly(methyl methacrylate) and polyvinyl chloride at a weight ratio of 82:18, a mixture of poly(methyl methacrylate) and polyphenylene oxide at a weight ratio of 65:35, a mixture of polystyrene and polyphenylene oxide at a weight ratio of 71:29, and a mixture of a styrene-maleic anhydride copolymer and polycarbonate at a weight ratio of 77:23; and so on, but the support medium is not limited to these examples. These support media may contain an additive such as an antioxidant, light stabilizer, heat stabilizer, lubricant, dispersant, ultraviolet absorber, white pigment, or fluorescent whitener as long as the aforementioned properties are not adversely affected.

The birefringent bodies 31, 32 described above are dispersedly arranged in the support medium 33 to form the reflective polarizer 30. The difference between the refractive index in the long axis direction or in the short axis direction of the birefringent bodies 31, 32 and the refractive index of the support medium 33 is preferably not less than 0.05, more preferably not less than 0.1, and particularly preferably not less than 0.2. As this refractive index difference becomes larger, incident light can be efficiently reflected backward and the thickness of the polarizer can be made smaller. In the case where the shape of the cross section perpendicular to the long axis direction of the birefringent bodies is polygonal, proportions of the fibers constituting the birefringent bodies 31, 32 and the substance constituting the support medium 33 is determined such that the fibers can be effectively fixed in the support medium. In the case where the shape of the cross section perpendicular to the long axis direction of the birefringent bodies is substantially circular, the proportions defined above may be determined if the fibers are effectively fixed in the support medium and if the birefringent bodies satisfy the condition that any one birefringent body, when viewed on the cross section perpendicular to the long axis direction of the birefringent body, is in contact on the side face of the circular cylinder with each of at least two other birefringent bodies in contact on the side face of the circular cylinder with each other. However, as shown in FIG. 3 or FIG. 4, in the case where the following conditions are satisfied: the birefringent bodies 31 constituted by fibers have a cross section of a triangle; the birefringent bodies 31 are so arranged that they are substantially parallel in the plane and apexes of sectional triangles of birefringent bodies 31 adjacent to each other are in contact with each other; in the cross section in the thickness direction of the reflective polarizer perpendicular to the long axis of the birefringent bodies 31, the support medium 33 surrounded by the birefringent bodies 31 of the sectional triangles with their apexes in contact with each other is hexagonal, for example, the volume ratio of (birefringent bodies 31)/(support medium 33) is 1/3. As shown in FIG. 5 or in FIG. 6, in the case where the birefringent bodies 31 with the cross section of a triangle or quadrangle are regularly arranged in the same orientation, the volume ratio of (birefringent bodies 31)/(support medium 33) is 1/1. Furthermore, as shown in FIG. 8, in the case where the birefringent bodies 31 composed of the fibers of the circular cylinders with the same diameter are close-packed in the support medium, the volume ratio of (birefringent bodies 31)/(support medium 33) is 1/(2×sqrt(3)/π−1), i.e., 1/(2\sqrt{3}/π−1)),

(where symbol “sqrt” is a square root).

There are no particular restrictions on the thickness “t” of the reflective polarizer 30 in the embodiment of the present invention. However, if the reflective polarizer is too thin, it will fail to achieve the polarization separation performance. On the other hand, if the reflective polarizer is too thick, it will increase the quantity of light absorbed thereby though it is reflective type and increase of material cost. Therefore, the thickness is normally in the appropriate range of 1 to 1000 micrometers (μm), preferably not less than 5 micrometers (μm), more preferably not less than 10 micrometers (μm), and preferably not more than 500 micrometers (μm), more preferably not more than 200 micrometers (μm).

The reflective polarizer of the embodiment of the present invention can be produced, for example, through three steps of: spinning and drawing fibers as birefringent bodies; preparing a nonwoven fabric in which these fibers are arranged in one direction; and impregnating this nonwoven fabric with the support medium to fix it. There are no particular restrictions on the spinning-drawing step of fibers as birefringent bodies and the production step of the nonwoven fabric, and they can be performed by well-known methods. The step of impregnating the nonwoven fabric with the support medium to fix it can be implemented by the following: a method of immersing the nonwoven fabric in a monomer and/or an oligomer as a precursor of the support medium and thereafter polymerizing the precursor of the support medium by light and/or heat; a method of immersing the nonwoven fabric in a polymer solution of the support medium and thereafter eliminating a solvent; a method of preparing the support medium in the form of fine powder, impregnating the nonwoven fabric with the fine powder, and thereafter melting the fine powder; and so on.

Furthermore, an effective alternative is a method of producing the reflective polarizer of the embodiment of the present invention by the melt extrusion method. Specifically, in the case where the shape of the cross section perpendicular to the long axis direction of the birefringent bodies dispersedly arranged in the support medium is polygonal, it is possible to adopt a profile extrusion method of extruding the resin for the birefringent bodies in the polygonal shape, by use of an extruder discharge port partitioned to form a number of dies, from every other die thereof, and extruding the resin for the support medium from other dies provided between the dies for the birefringent bodies. In the case where the shape of the cross section perpendicular to the long axis direction of the birefringent bodies dispersedly arranged in the support medium is substantially circular, it is possible to adopt a profile extrusion method of extruding the resin for the birefringent bodies in a round rod shape, by use of an extruder discharge port partitioned to form a number of dies continuous in the cross section, from a part of the dies thereof, and extruding the resin forming the support medium, from other dies provided between the dies for the birefringent bodies. In these cases, the extruder and dies can be designed so as to form the aforementioned dispersedly arranged structure by extruding the different types of molten resins alternately in the predetermined shapes from the dies of the extruder.

In use of the reflective polarizer of the embodiment according to the present invention, an optical layer with another optical function can be formed on at least one surface of the reflective polarizer to form a laminated optical member. For the purpose of forming the laminated optical member, the optical layer to be formed on the reflective polarizer of the embodiment of the present invention can be, for example, an absorptive polarizer, a retardation plate, or the like.

Particularly, when an absorptive polarizer is laminated on the reflective polarizer of the embodiment of the present invention, the laminated optical member can be used as a luminance-improving film intended for improving the luminance in the liquid crystal display apparatus or the like. Specifically, when the absorptive polarizer and the reflective polarizer of the embodiment of the present invention are so arranged that the transmission axes of them are substantially parallel and that the reflective polarizer is located on the backlight side while the absorptive polarizer on the liquid crystal cell side, linearly polarized light is transmitted by the reflective polarizer and the transmitted light is emitted toward the liquid crystal cell while its direction is aligned in the absorptive polarizer; on the other hand, linearly polarized light is reflected on the reflective polarizer and the reflected light returns to the backlight side to be reused. An example of the absorptive polarizer is one formed as follows: a dichroic dye such as iodine or a dyestuff is made to be adsorbed on uniaxially oriented polyvinyl alcohol, it is cross-linked with boric acid to form a polarizer, and a transparent film of triacetylcellulose or the like is bonded to at least one surface of the polarizer.

Further effective utilization of reflected light can be achieved by a retardation plate laminated on the reflective polarizer of the embodiment of the present invention. Specifically, the reflective polarizer reflects linearly polarized light and the reflected light is converted into circularly polarized light by the retardation plate and the circularly polarized light is fed back to the backlight. Polarization inversion occurs upon reflection on a reflecting plate of the backlight to produce light of the other circularly polarization reverse to that of light before reflection. After this light passes again through the retardation plate, it turns into light linearly polarized in the direction perpendicular to the linearly polarized original light, and the resultant light linearly polarized passes through the reflective polarizer. This achieves effective utilization of light. In this case, a quarter wave plate is advantageously used as the retardation plate. When the quarter wave plate is laminated on the reflective polarizer, they may be arranged so that the transmission axis of the reflective polarizer intersects at the angle of 45° or at the angle of 135° with the retardation axis of the quarter wave plate. Examples of the retardation plate are listed below: a birefringent film constituted by a drawn film of various plastics such as polycarbonate and cyclic polyolefins; a film in which a discotic liquid crystal or nematic liquid crystal is oriented and fixed; a plate in which the foregoing liquid crystal layer is formed a film base; and so on.

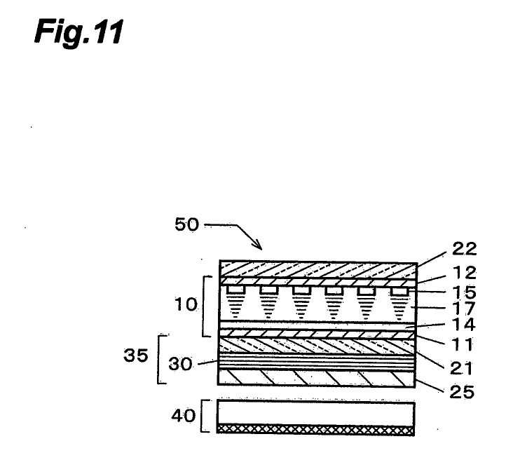

As shown in FIG. 11, it is also effective to laminate the absorptive polarizer 21 on one surface of the reflective polarizer 30 and to laminate the retardation plate 25 on the other surface thereof, thereby forming a laminated optical member 35. The principle of this case is the same as described about the above cases where only the absorptive polarizer is laminated and where only the retardation plate is laminated, and in this case, the quarter wave plate is also advantageously used as the retardation plate. In this case, these members may be arranged so that the transmission axis of the reflective polarizer 30 and the transmission axis of the absorptive polarizer 21 are substantially parallel to each other and so that the transmission axis of the reflective polarizer 30 intersects substantially at the angle of 45° or at the angle of 135° with the retardation axis of the quarter wave plate 25. The laminated optical member constructed as shown in FIG. 11 more effectively acts as a luminance-improving film intended for improving the luminance in the liquid crystal display apparatus or the like.

For producing the laminated optical member, an adhesive is used to integrate the reflective polarizer with the optical layer such as the absorptive polarizer or the retardation plate, and there are no particular restrictions on the adhesive used for that purpose as long as an adhesive layer is formed well. In terms of simplicity of the bonding or prevention of occurrence of optical distortion, it is preferable to use a tackiness agent (also referred to as “a pressure-sensitive adhesive”). The tackiness agent can contain a base polymer such as an acrylic polymer, silicone polymer, polyester, polyurethane, or polyether.

Among others, it is preferable to use an agent that satisfied the following: it is excellent in optical transparency; it has moderate wettability and cohesion; it is also excellent in adhesion to the base, that has satisfactory weather resistance and heat resistance; and it is free of the delamination problem such as a rise or peeling under heat and humidity conditions, like acrylic tackiness agents. A useful base polymer for the acrylic tackiness agents is, for example, an acrylic copolymer with the weight-average molecular weight of not less than 100,000 obtained by blending an alkyl ester of (meth)acrylic acid having an alkyl group with 20 or less carbons, such as a methyl group, an ethyl group, or a butyl group, and a functionalized acrylic monomer such as (meth)acrylic acid or hydroxyethyl (meth)acrylate so as to achieve the glass transition temperature, preferably, of not more than 25° C., more preferably not more than 0° C., and polymerizing them.

The tackiness agent layer can be formed on the polarizer, for example, by the following methods: a method of dissolving or dispersing a tackiness agent composition in an organic solvent such as toluene or ethyl acetate to prepare a solution of 10-40% by weight and directly applying it onto the polarizer to form the tackiness agent layer; a method of preliminarily forming the tackiness agent layer on a protect film and transferring it onto the polarizer to form the tackiness agent layer thereon; and so on. The thickness of the tackiness agent layer is optionally determined according to the adhesion thereof or the like, and is normally in the range of 1 to 50 micrometers (μm).

The tackiness agent layer may contain filler such as glass fiber, glass beads, resin beads, metal powder, or other inorganic powder, a pigment, a colorant, an antioxidant, or an ultraviolet absorber. Examples of the ultraviolet absorber include salicylic ester compounds, benzophenone compounds, benzotriazole compounds, cyanoacrylate compounds, nickel complex compounds, and so on.

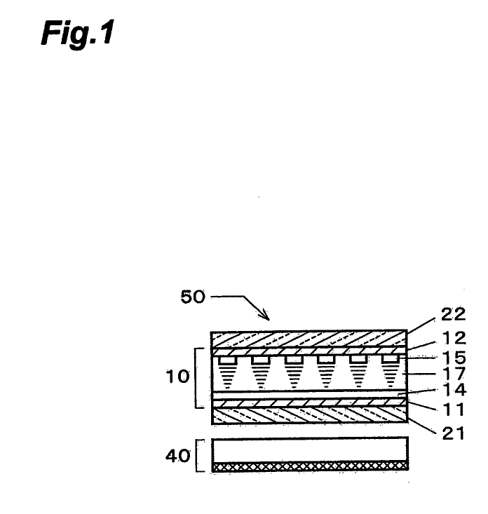

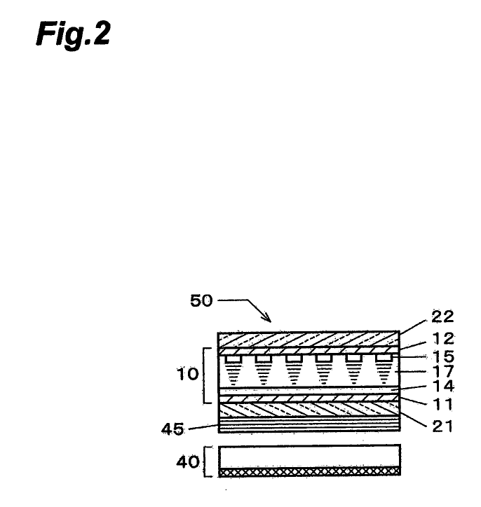

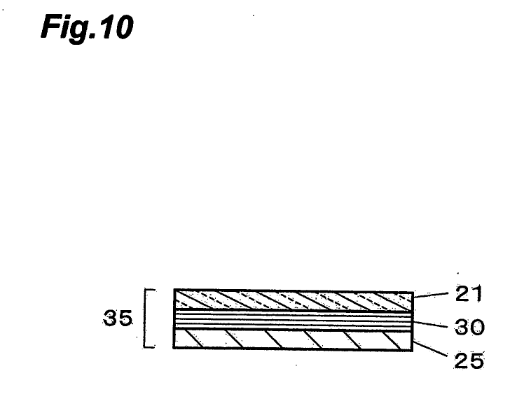

The laminated optical member, in the form similar to that shown in FIG. 2, can be applied to the liquid crystal cell, instead of the reflective polarizer 45 in FIG. 2 or instead of the laminate of the reflective polarizer 45 and absorptive polarizer 21, to form a liquid crystal display apparatus. FIG. 11 shows an example in which the laminated optical member 35 including the layer structure of absorptive polarizer 21/reflective polarizer 30/retardation plate 25 shown in FIG. 10 is incorporated in the liquid crystal display apparatus. FIG. 11 shows the arrangement of the laminated optical member 35, which is the same as that shown in FIG. 10, provided toward the backlight 40 of the liquid crystal cell 10, and the other reference symbols are the same as in FIGS. 1 and 2, which will be omitted from the description herein.

The liquid crystal cell to be used in the liquid crystal display apparatus can be any liquid crystal cell; for example, the liquid crystal display apparatus can be formed by using a variety of liquid crystal cells such as active matrix drive type cells typified by the thin film transistor type and simple matrix drive type cells typified by the super-twisted nematic type.

The reflective polarizer of the embodiment of the present invention, and the laminated optical member provided therewith can be suitably applied to display screens using the liquid crystal cell, such as personal computers, word processors, engineering workstations, personal digital assistants, navigation systems, liquid crystal TV monitors, and video players, and realize an improvement in luminance and a reduction in power consumption.

### EXAMPLES

Calculation examples by simulation will be shown below: a case where triangular prisms with the sectional shape of a regular triangle are uniformly dispersed in the support medium; a case where triangular prisms with the sectional shape of an isosceles triangle are uniformly dispersed in the support medium; a case where rectangular prisms with the sectional shape of a square are uniformly dispersed in the support medium; a case where circular cylinders with the sectional shape of a circle are closely dispersed in the support medium; and a case where circular cylinders with the sectional shape of a circle are relatively sparsely dispersed in the support medium. The calculation for the degree of polarization hereinafter was performed using ray-tracing software “Trace Pro 2.3.4” (available from Lambda Research Corp.).

### Example 1

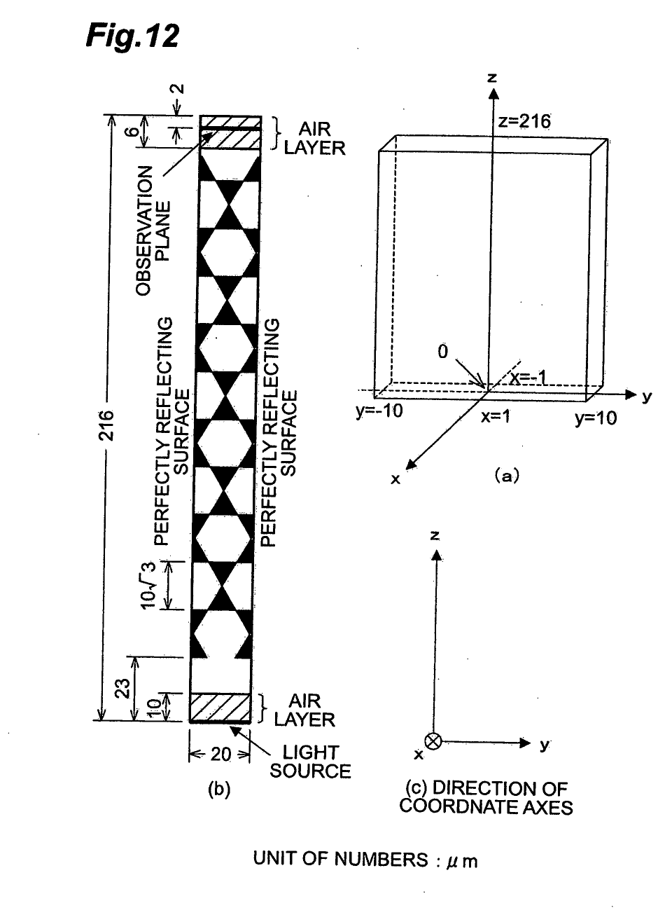

This example shows optical characteristics in the case where six triangular prisms with the sectional shape of a regular triangle are in contact with each other at the apexes of the respective sectional regular triangles to form a regular hexagonal prism, i.e., where triangular prisms are uniformly dispersed in the support medium in the form of the Star of David. The orthogonal coordinate system of the right hand system to express positions in the simulation space is defined as (x,y,z) and the schematic view of the system used in the calculation in this example is presented in FIG. 12. In FIG. 12, part (a) schematically shows a rectangular parallelepiped region used in the calculation, on the right-hand (x,y,z) orthogonal coordinate system, part (b) is a schematic sectional view, taken along the y-z plane at x=0, of this rectangular parallelepiped, and part (c) shows the direction of the coordinate system in part (b). It is noted that in these drawings, particularly, in part (a), the scale size does not correspond to the original size. Numerals in the drawing are expressed in units of micrometer (μm). In part (b), hatched regions represent air layers, blackened portions represent the layers of the triangular prisms, and white portions represent the layers of the support medium.

The domain used in the calculation is defined by the range of coordinate x of −1 micrometer to 1 micrometer both inclusive, the range of coordinate y of −10 micrometers to 10 micrometers both inclusive, and the range of coordinate z of 0 micrometer to 216 micrometers both inclusive. That is, as shown in part (a) in FIG. 12, it is inside the rectangular parallelepiped defined below.
−1 μm≦x≦1 μm,
−10 μm≦y≦10 μm, and
0≦z≦216 μm.

Two planes at y=−10 micrometers (μm) and at y=10 micrometers (μm) parallel to the z-x plane are assumed to be both perfectly reflecting surfaces. On the other hand, a light source is defined as a line segment at x=z=0 and in parallel to the y-axis in the range of −10 micrometers (μm) to 10 micrometers (μm) both inclusive, and generates 5001 rays in the positive direction of the z-axis.

Regions in the calculation domain in the range of z-coordinate of 0 micrometer to 10 micrometers both inclusive (0≦z≦10 μm) and in the range of z-coordinate of 210 micrometers to 216 micrometers both inclusive (210 μm≦z≦216 μm) are defined as air layers (refractive index 1), and a plane at z=214 micrometers (μm) parallel to the x-y plane is defined as an observation plane. A region in the calculation domain in the range of z-coordinate of 10 micrometers to 210 micrometers both inclusive (10 μm≦z≦210 μm) is defined as a region of the polarizer, and the refractive index thereof is assumed to be 1.5, except for the regions of the triangular prisms described below.

The triangular prisms are assumed to be regular triangular prisms having the refractive index of 1.8, the axis in the x-axis direction, the bottom faces of 10 micrometers (μm) on each side, and the height of 2 micrometers (μm). One bottom face thereof is set so as to be included in the plane at x=−1 micrometer (μm) parallel to the y-z plane. Thirty two triangular prisms are set and the positions of the respective triangular prisms are defined below by regular triangles of cross sections of the triangular prisms taken at x=0 and on the y-z plane. In the expression below, symbol “*” represents multiplication.

Namely, the triangular prisms constituted by those defined as follows:

triangular prisms defined by regular triangles each having one apex at the y-coordinate and the z-coordinate defined below;
(y,z)=(−10,23+5*sqrt(3)),
(−10,23+25*sqrt(3)),
(−10,23+45*sqrt(3)),
(−10,23+65*sqrt(3)),
(−10,23+85*sqrt(3)),
(−10,23+105*sqrt(3)),
(10,23+5*sqrt(3)),
(10,23+25*sqrt(3)),
(10,23+45*sqrt(3)),
(10,23+65*sqrt(3)),
(10,23+85*sqrt(3)),
(10,23+105*sqrt(3)),
(0,23+15*sqrt(3)),
(0,23+35*sqrt(3)),
(0,23+55*sqrt(3)),
(0,23+75*sqrt(3)),
(0,23+95*sqrt(3)),
and the opposite side to the apex being parallel to the y-axis and having the z-coordinate defined below;
z 23,
23+20*sqrt(3),
23+40*sqrt(3),
23+60*sqrt(3),
23+80*sqrt(3),
23+100*sqrt(3),
23,
23+20*sqrt(3),
23+40*sqrt(3),
23+60*sqrt(3),
23+80*sqrt(3),
23+100*sqrt(3),
23+10*sqrt(3),
23+30*sqrt(3),
23+50*sqrt(3),
23+70*sqrt(3),
23+90*sqrt(3),
(which are upwardly pointed regular triangles in part (b) in FIG. 12); and

triangular prisms defined by regular triangles each having one apex at the y-coordinate and the z-coordinate defined below;
(y,z)=(−10,23+5*sqrt(3)),
(−10,23+25*sqrt(3)),
(−10,23+45*sqrt(3)),
(−10,23+65*sqrt(3)),
(−10,23+85*sqrt(3)),
(10,23+5*sqrt(3)),
(10,23+25*sqrt(3)),
(10,23+45*sqrt(3)),
(10,23+65*sqrt(3)),
(10,23+85*sqrt(3)),
(0,23+15*sqrt(3)),
(0,23+35*sqrt(3)),
(0,23+55*sqrt(3)),
(0,23+75*sqrt(3)),
(0,23+95*sqrt(3)),
and the opposite side to the apex being parallel to the y-axis and having the z-coordinate defined below;
z=23+10sqrt(3),
23+30*sqrt(3),
23+50*sqrt(3),
23+70*sqrt(3),
23+90*sqrt(3),
23+10*sqrt(3),
23+30*sqrt(3),
23+50*sqrt(3),
23+70*sqrt(3),
23+90*sqrt(3),
23+20*sqrt(3),
23+40*sqrt(3),
23+60*sqrt(3),
23+80*sqrt(3),
23+100*sqrt(3),
(which are downwardly pointed regular triangles in part (b) in FIG. 12). The above numerals are calculated to six places of decimals and parts of the numerals that are off the domain used in the calculation are ignored.

With the above-described calculation system, polarized light with the electric field vector parallel to the x-axis is used as incident light, the energy of rays passing through the observation plane is calculated and referred to ass Eₓ.

Next, with a system obtained by substituting 1.5 for the refractive index of the triangular prisms in the above-described calculation system, similar calculation is performed using polarized light with the electric field vector parallel to the y-axis as incident light, and the energy of rays passing through the observation plane is defined as E_{y}. This calculation with the substitution for the refractive index of triangular prisms is conducted as simulation in the case where the birefringent bodies are dispersed.

Furthermore, assuming that the total energy of rays emitted from the light source is E₀, the transmittance Tₓ for the polarized light with the electric field vector parallel to the x-axis and the transmittance T_{y} for the polarized light with the electric field vector parallel to the y-axis can be defined respectively as follows:
Tₓ=Eₓ/E₀, and
T_{y}=E_{y}/E₀,
and the polarization degree P can be calculated as:
P=(T_{y}−Tₓ)/(T_{y}+Tₓ).
In the calculation system of this example, the calculation results were as follows: Tₓ=0, T_{y}=0.922, and P=1.00.

In this example, the calculation is conducted using the regular triangular prisms having the height of 2 micrometers (μm) and the cross section of the regular triangle of sides of 10 micrometers (μm), and therefore the aspect ratio, if calculated literally therefrom, is smaller than 1. However, the system used in the calculation is in plane symmetry with respect to the z-x plane at y=0, and the two planes at y=−10 micrometers (μm) and at y=10 micrometers (μm) parallel to the z-x plane are perfectly reflecting surfaces, which provides the same effect as in the case where a periodic boundary condition in the y-axis direction is imposed on the system used in the calculation. Therefore, it is the same as the case where the triangular prisms have the height of infinity and the aspect ratio of infinity.

### Example 2

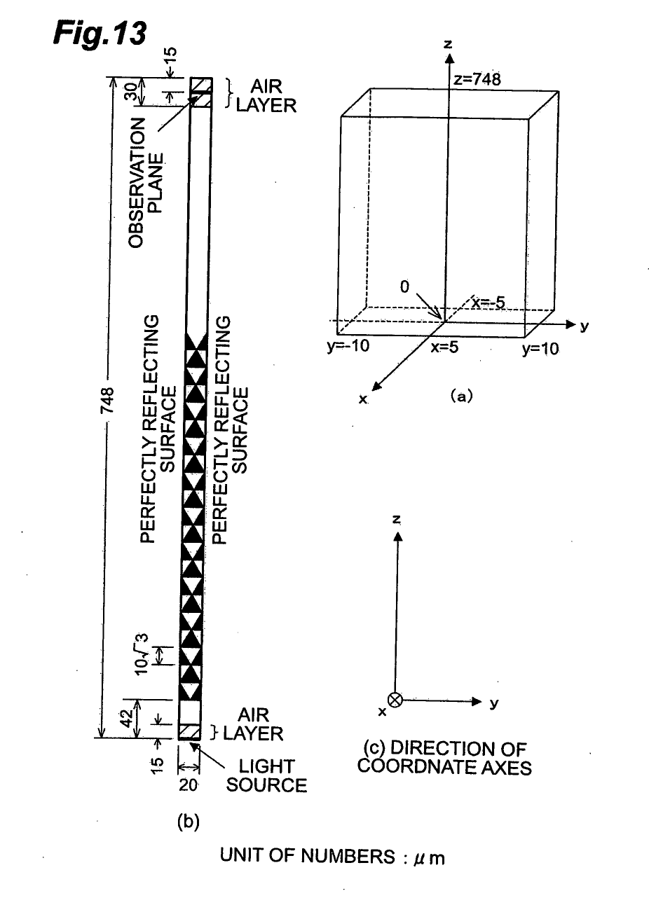

This example shows optical characteristics in the case where the triangular prisms are uniformly dispersed in the support medium so that three triangular prisms with the sectional shape of a regular triangle are in contact at respective apexes of sectional regular triangles to form a regular triangular prism. The orthogonal coordinate system of the right hand system to express positions in the space is defined by (x,y,z) and the schematic view of the system used in the calculation in this example is presented in FIG. 13. In FIG. 13 part (a) schematically shows a rectangular parallelepiped region used in the calculation in the right-hand (x,y,z) orthogonal coordinate system, part (b) is a schematic sectional view of this rectangular parallelepiped on the y-z plane at x=0, and part (c) shows the directions of the coordinate axes in part (b). It is noted that in these drawings, particularly, in part (a), the scale size does not correspond to the original size. The unit of numerals in the drawing is micrometer (μm). In part (b), hatched regions represent air layers, blackened portions represent the layers of the triangular prisms, and white portions represent the layers of the support medium.

The domain used in the calculation is defined by the x-coordinate range of −5 micrometers to 5 micrometers both inclusive, the y-coordinate range of −10 micrometers to 10 micrometers both inclusive, and the z-coordinate range of 0 micrometer to 748 micrometers both inclusive, and is thus inside the rectangular parallelepiped defined below, as shown in part (a) in FIG. 13:
−5 μm≦x≦5 μm,
−10 μm≦y≦10 μm, and
0≦z≦748 μm.

Two planes at y=−10 micrometers (μm) and at y=10 micrometers (μm) parallel to the z-x plane are assumed to be perfectly reflecting planes. On the other hand, a light source is defined as a line segment parallel to the y-axis at x=z=0 and in the y-coordinate range of −10 micrometers (μm) to 10 micrometers (μm) both inclusive, and the light source generates 5001 rays in the positive direction of the z-axis.

Regions in the calculation domain in the z-coordinate range of 0 to 15 micrometers both inclusive (0≦z≦15 μm) and in the z-coordinate range of 718 to 748 micrometers both inclusive (718 μm≦z ≦748 μm) are defined as air layers (refractive index 1) and a plane parallel to the x-y plane at z=733 micrometers (μm) is defined as an observation plane. A region in the calculation domain in the z-coordinate range of 15 to 718 micrometers both inclusive (15 μm≦z≦718 μm) is defined as a region of the polarizer and the refractive index thereof is assumed to be 1.3, except for the regions of the triangular prisms described below.

The triangular prisms are assumed to be regular triangular prisms having the refractive index of 1.9, the axis along the x-axis direction, the bottom faces of 20 micrometers (μm) on each side, and the height of 10×sqrt3 (10\sqrt{3}μm). One bottom face thereof is set so as to be included in the plane at x=−5 micrometers (μm) parallel to the y-z plane. Thirty two triangular prisms are set and the positions of the respective triangular prisms are defined below by regular triangles of cross sections of the triangular prisms taken at x=0 and on the y-z plane.

Namely, the triangular prisms are constituted by those defined as follows:

triangular prisms defined by regular triangles each having one apex at the y-coordinate and the z-coordinate defined below;
(y,z)=(−10,42+10*sqrt(3)),
(−10,42+30*sqrt(3)),
(−10,42+50*sqrt(3)),
(−10,42+70*sqrt(3)),
(−10,42+90*sqrt(3)),
(−10,42+100*sqrt(3)),
(−10,42+130*sqrt(3)),
(−10,42+150*sqrt(3)),
(−10,42+170*sqrt(3)),
(−10,42+190*sqrt(3)),
(−10,42+210*sqrt(3)),
(10,42+10*sqrt(3)),
(10,42+30*sqrt(3)),
(10,42+50*sqrt(3)),
(10,42+70*sqrt(3)),
(10,42+90*sqrt(3)),
(10,42+110*sqrt(3)),
(10,42+130*sqrt(3)),
(10,42+150*sqrt(3)),
(10,42+170*sqrt(3)),
(10,42+190*sqrt(3)),
(10,42+210*sqrt(3)),
(0,42+20*sqrt(3)),
(0,42+40*sqrt(3)),
(0,42+60*sqrt(3)),
(0,42+80*sqrt(3)),
(0,42+100*sqrt(3)),
(0,42+120*sqrt(3)),
(0,42+140*sqrt(3)),
(0,42+160*sqrt(3)),
(0,42+180*sqrt(3)),
(0,42+200*sqrt(3)),
and the opposite side to the apex being parallel to the y-axis and having the z-coordinate defined below;
z=42,
42+20*sqrt(3),
42+40*sqrt(3),
42+60*sqrt(3),
42+80*sqrt(3),
42+100*sqrt(3),
42+120*sqrt(3),
42+140*sqrt(3),
42+160*sqrt(3),
42+180*sqrt(3),
42+200*sqrt(3),
42,
42+20*sqrt(3),
42+40*sqrt(3),
42+60*sqrt(3),
42+80*sqrt(3),
42+100*sqrt(3),
42+120*sqrt(3),
42+140*sqrt(3),
42+160*sqrt(3),
42+180*sqrt(3),
42+200*sqrt(3),
42+10*sqrt(3),
42+30*sqrt(3),
42+50*sqrt(3),
42+70*sqrt(3),
42+90*sqrt(3),
42+110*sqrt(3),
42+130*sqrt(3),
42+150*sqrt(3),
42+170*sqrt(3),
42+190*sqrt(3),
(which are blackened upwardly pointed regular triangles in part (b) of FIG. 13). However, the above numerals are calculated to six places of decimals and parts of the numerals that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are: the transmittance Tₓ=0, T_{y}=0.966, and the polarization degree P=1.00.

In this example the calculation is conducted using the regular triangular prisms the height of 10 micrometers (μm) and having the cross section of the regular triangle having sides of 20 micrometers (μm), and, because the system used in the calculation is in plane symmetry with respect to the z-x plane at y=0, and the two planes at y=−10 micrometers (μm) and at y=0 micrometers (μm) parallel to the z-x plane are assumed to be perfectly reflecting planes, the same assumption can be made as in the case where the triangular prisms have the height of infinity and the aspect ratio of infinity, which is the same as in Example 1.

### Example 3

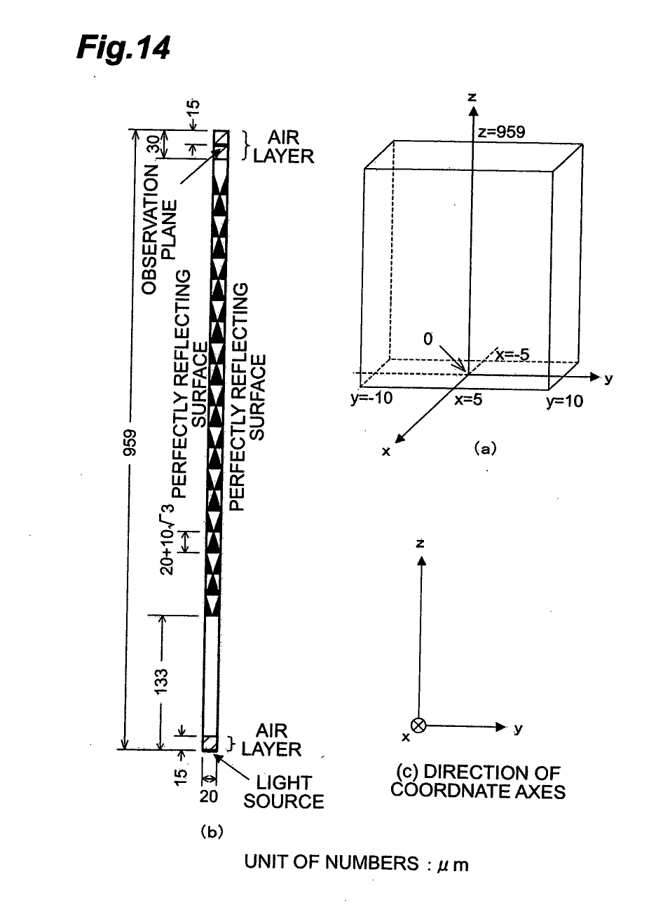

This example shows optical characteristics in the case where triangular prisms are uniformly dispersed in the support medium so that three triangular prisms having the sectional shape of an isosceles triangle are in contact with apexes of bottoms of the other isosceles triangles at an apex of an apex angle in each sectional isosceles triangle so as to form an isosceles triangular prism. The orthogonal coordinate system of the right hand system to express positions in the region is defined by (x,y,z) and the schematic view of the system used in the calculation in this example is presented in FIG. 14. In FIG. 14 part (a) schematically shows a rectangular parallelepiped region used in the calculation on the right-hand (x,y,z) orthogonal coordinate system, part (b) is a schematic sectional view of this rectangular parallelepiped on the y-z plane at x=0, and part (c) shows the directions of the coordinate axes in part (b). It is noted that in these drawings, particularly, in part (a), the scale size does not correspond to the original size. The unit of numerals in the drawing is micrometer (μm). In part (b), hatched regions represent air layers, blackened portions represent the layers of the triangular prisms, and white portions represent the layers of the support medium.

The domain used in the calculation is defined by the x-coordinate range of −5 micrometers (μm) to 5 micrometers (μm) both inclusive, the y-coordinate range of −10 (μm) micrometers to 10 (μm) micrometers both inclusive, and the z-coordinate range of 0 micrometer to 959 micrometers (μm) both inclusive, and the domain is thus inside the rectangular parallelepiped defined below as shown in part (a) in FIG. 14:
−5 μm≦x≦5 μm,
−10 μm≦y≦10 μm, and
0≦z≦959 μm.

Two planes at y=−0 micrometers (μm) and at y=10 micrometers (μm) parallel to the z-x plane are assumed to be perfectly reflecting planes. On the other hand, a light source is defined as a line segment parallel to the y-axis at x=z=0 and in the y-coordinate range of −10 micrometers (μm) to 10 micrometers (μ) both inclusive, and the light source generates 5001 rays in the positive direction of the z-axis.

Regions in the calculation domain in the z-coordinate range of 0 to 15 micrometers both inclusive (0≦z≦15 μm) and in the z-coordinate range of 929 micrometers to 959 micrometers both inclusive (929 μm≦z≦959 μm) are defined as air layers (refractive index 1) and a plane parallel to the x-y plane at z=944 micrometers (μm) is defined as an observation plane. A region in the calculation domain in the z-coordinate range of 15 micrometers to 929 micrometers both inclusive (15 μm≦z≦929 μm) is defined as a region of the polarizer and the refractive index thereof is assumed to be 1.3, except for the regions of the triangular prisms described below.

The triangular prisms have the refractive index of 1.8, the axis extending in the x-axis direction, and the isosceles triangle having the bottom faces of the bottom of 20 micrometers (μm), the height of 20+10×sqrt(3) micrometers (μm) and the apex angle of 30°, and one bottom face thereof is set so as to be included in the plane parallel to the y-z plane at x=−5 micrometers (μm). Thirty two triangular prisms are set and the positions of the respective triangular prisms are defined below by isosceles triangles of cross sections of the triangular prisms at x0 and on the y-z plane.

Namely, the triangular prisms are constituted by those defined as follows:

triangular prisms defined by isosceles triangles each having one apex at the y-coordinate and the z-coordinate defined below;
(y,z)=(−10,153+10*sqrt(3)),
(−10,193+30*sqrt(3)),
(−10,233+50*sqrt(3)),
(−10,273+70*sqrt(3)),
(−10,313+90*sqrt(3)),
(−10,353+110*sqrt(3)),
(−10,393+130*sqrt(3)),
(−10,433+150*sqrt(3)),
(−10,473+170*sqrt(3)),
(−10,513+190*sqrt(3)),
(−10,553+210*sqrt(3)),
(10,153+10*sqrt(3)),
(10,193+30*sqrt(3)),
(10,233+50*sqrt(3)),
(10,273+70*sqrt(3)),
(10,313+90*sqrt(3)),
(10,353+110*sqrt(3)),
(10,393+130*sqrt(3)),
(10,433+150*sqrt(3)),
(10,473+170*sqrt(3)),
(10,513+190*sqrt(3)),
(10,553+210*sqrt(3)),
(0,173+20*sqrt(3)),
(0,213+40*sqrt(3)),
(0,253+60*sqrt(3)),
(0,293+80*sqrt(3)),
(0,333+100*sqrt(3)),
(0,373+120*sqrt(3)),
(0,413+140*sqrt(3)),
(0,453+160*sqrt(3)),
(0,493+180*sqrt(3)),
(0,533+200*sqrt(3)),
and the opposite side to the apex being parallel to the y-axis and having the z-coordinate defined below;
z=133,
173+20*sqrt(3),
213+40*sqrt(3),
253+60*sqrt(3),
293+80*sqrt(3),
333+100*sqrt(3),
373+120*sqrt(3),
413+140*sqrt(3),
453+160*sqrt(3),
493+180*sqrt(3),
533+200*sqrt(3),
133,
173+20*sqrt(3),
213+40*sqrt(3),
253+60*sqrt(3),
293+80*sqrt(3),
333+100*sqrt(3),
373+120*sqrt(3),
413+140*sqrt(3),
453+160*sqrt(3),
493+180*sqrt(3),
533+200*sqrt(3),
153+10*sqrt(3),
193+30*sqrt(3),
233+50*sqrt(3),
273+70*sqrt(3),
313+90*sqrt(3),
353+110*sqrt(3),
393+130*sqrt(3),
433+150*sqrt(3),
473+170*sqrt(3),
513+190*sqrt(3),
(which are blackened upwardly pointed regular triangles in part (b) of FIG. 14). However, the above numerals are calculated to six places of decimals and parts of the numerals that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are as follows: Tₓ=0, T_{y}=0.966, and the polarization degree P=100.

In this example, the calculation is conducted using the isosceles triangular prisms having the height of 10 micrometers (μm) and the cross section of the isosceles triangle with the bottom of 20 micrometers (μm), the height of 20+10×sqrt(3) micrometers (μm), and the apex angle of 30°, and, because the system used in the calculation is in plane symmetry with respect to the z-x plane at y=0 and the two planes at y=−10 micrometers (μm) and at y=10 micrometers (μm) parallel to the z-x plane are assumed to be perfectly reflecting planes, the same assumption can be made as in the case where the triangular prisms have the height of infinity and the aspect ratio of infinity, which is the same as in Example 1.

### Example 4

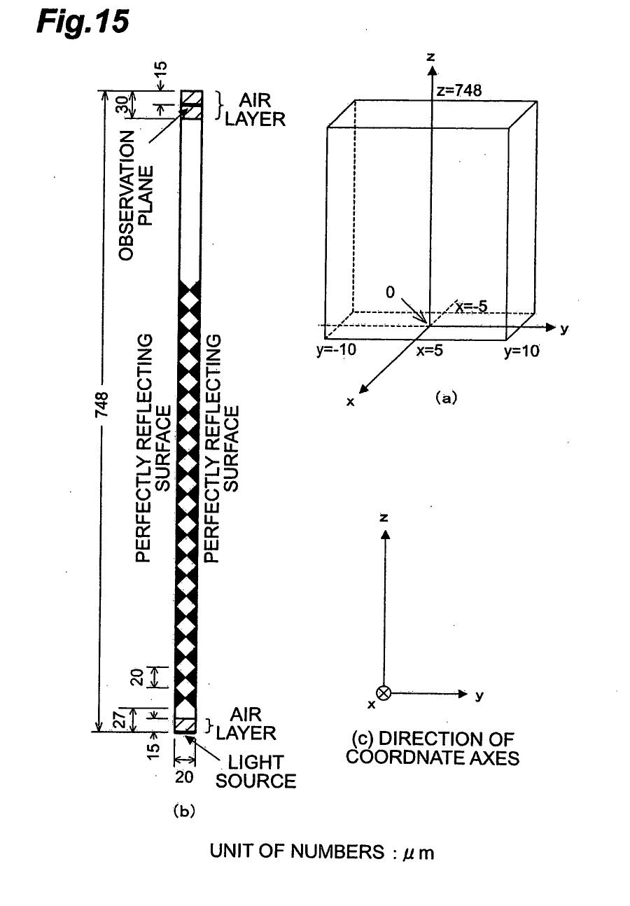

This example shows optical characteristics in the case where rectangular prisms are uniformly dispersed in the support medium so that four rectangular prisms having the sectional shape of a square are in contact at apexes of respective sectional squares to form a square. The orthogonal coordinate system of the right hand system to express positions in the region is defined by (x,y,z) and the schematic view of the system used in the calculation in this example is presented in FIG. 15. In FIG. 15 part (a) schematically shows a rectangular parallelepiped region used in the calculation on the right-hand (x,y,z) orthogonal coordinate system, part (b) is a schematic sectional view of this rectangular parallelepiped on the y-z plane at x=0 and part (c) shows the directions of the coordinate axes in part (b). It is noted that in these figures, particularly, in part (a), the scale size does not correspond to the original size. The unit of numerals in the drawing is micrometer (μm). In part (b), hatched regions represent air layers, blackened portions the layers of the rectangular prisms, and white portions the layers of the support medium.

The domain used in the calculation is defined by the x-coordinate range of −5 micrometers to 5 micrometers both inclusive, the y-coordinate range of −10 micrometers to 10 micrometers both inclusive, and the z-coordinate range of 0 micrometer to 748 micrometers both inclusive, and is thus inside the rectangular parallelepiped defined below as shown in part (a) in FIG. 15:
−5 μm≦x≦5 μm,
−10 μm≦y≦10 μm, and
0≦z≦748 μm.

Two planes at y=−10 micrometers (μm) and at y=10 micrometers (μm) parallel to the z-x plane are assumed to be perfectly reflecting planes. On the other hand, a light source is defined as a line segment parallel to the y-axis at x=z=0 and in the y-coordinate range of −10 micrometers to 10 micrometers (−10 μm≦y≦10 μm) both inclusive, and the light source generates 5001 rays in the positive direction of the z-axis.

Regions in the calculation domain in the z-coordinate range of 0 to 15 micrometers both inclusive (0≦z≦15 μm) and in the z-coordinate range of 718 micrometers to 748 micrometers both inclusive (718 μm≦z≦748 μm) are defined as air layers (refractive index 1) and a plane parallel to the x-y plane at z=733 micrometers (μm) is defined as an observation plane. A region in the calculation domain in the z-coordinate range of 15 micrometers (μm) to 718 micrometers (μm) both inclusive (15 μm≦z≦718 μm) is defined as a region of the polarizer and the refractive index thereof is assumed to be 1.7, except for the regions of the rectangular prisms described below.

The rectangular prisms are square prisms having the refractive index of 1.2, the axis extending in the x-axis direction, and each side of the bottom faces of 10×sqrt(2) micrometers (10\sqrt{2}μm), and one bottom face thereof is included in the plane parallel to the y-z plane at x=−5 micrometers (μm). Forty two rectangular prisms are set, and the positions of the respective rectangular prisms are defined below by squares of cross sections of the rectangular prisms on the y-z plane at x=0.

Namely, the rectangular prisms are constituted by the total of forty two prisms (in 21 layers in the z-axis direction) each of which is surrounded by four apexes at the y-coordinates and z-coordinates in a square defined as follows.

1. (y, z) = (−10, 27), (0, 37), (−10, 47), (−20, 37);
2. (y, z) = (10, 27), (0, 37), 10(, 47), (20, 37);
3. (y, z) = (−10, 47), (0, 57), (−10, 67), (−20, 57);
4. (y, z) = (10, 47), (0, 57), (10, 67), (20, 57);
5. (y, z) = (−10, 67), (0, 77), (−10, 87), (−20, 77);
6. (y. z) = (10, 67), (0, 77), (10, 87), (20, 77);
7. (y, z) = (−10, 87), (0, 97), (−10, 107), (−20, 97);
8. (y, z) = (10, 87), (0, 97), (10, 107), (20, 97);
9. (y, z) = (−10, 107), (0, 117), (−10, 127), (−20, 117);
10. (y, z) = (10, 107), (0, 117), (10, 127), (20, 117);
11. (y, z) = (−10, 127), (0, 137), (−10, 147), (−20, 137);
12. (y, z) = (10, 127), (0, 137), (10, 147), (20, 137);
13. (y, z) = (10, 147), (0, 157), (−10, 167), (−20, 157);
14. (y, z) = (10, 147), (0, 157), (10, 167), (20, 157);
15. (y, z) = (−10, 167), (0, 177), (−10, 187), (−20, 177);
16. (y, z) = (10, 167), (0, 177), (10, 187), (20, 177);
17. (y, z) = (−10, 187), (0, 197), (−10, 207); (−20, 197);
18. (y, z) = (10, 187), (0, 197), (10, 207), (20, 197);
19. (y, z) = (−10, 207), (0, 217), (−10, 227), (−20, 217);
20. (y, z) = (10, 207), (0, 217), (10, 227), (20, 217);
21. (y, z) = (−10, 227), (0, 237), (−10, 247), (−20, 237);
22. (y, z) = (10, 227), (0, 237), (10, 247), (20, 237);
23. (y, z) = (−10, 247), (0, 257), (−10, 267), (−20, 257);
24. (y, z) = (10, 247), (0, 257), (10, 267), (20, 257);
25. (y, z) = (−10, 267), (0, 277), (−10, 287), (−20, 277);
26. (y, z) = (10, 267), (0, 277), (10, 287), (20, 277);
27. (y, z) = (−10, 287), (0, 297), (−10, 307), (−20, 297);
28. (y, z) = (10, 287), (0, 297), (10, 307), (20, 297);
29. (y, z) = (−10, 307), (0, 317), (−10, 327); (−20, 317);
30. (y, z) = (10, 307), (0, 317), (10, 327), (20, 317);
31. (y, z) = (−10, 327), (0, 337), (−10, 347), (−20, 337);
32. (y, z) = (10, 327), (0, 337), (10, 347), (20, 337);
33. (y, z) = (−10, 347), (0, 357), (−10, 367), (−20, 357);
34. (y, z) = (10, 347), (0, 357), (10, 367), (20, 357);
35. (y, z) = (−10, 367), (0, 377), (−10, 387), (−20, 377);
36. (y, z) = (10, 367), (0, 377), (10, 387), (20, 377);
37. (y, z) = (−10, 387), (0, 397), (−10, 407), (−20, 397);
38. (y, z) = (10, 387), (0, 397), (10, 407), (20, 397);
39. (y, z) = (−10, 407), (0, 417), (−10, 427), (−20, 437);
40. (y, z) = (10, 407), (0, 417), (10, 427), (20, 417);
41. (y, z) = (−10, 427), (0, 437), (−10, 447), (−20, 437);
42. (y, z) = (10, 427), (0, 437), (10, 447), (20, 437).

However, portions that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are as follows: Tₓ=0, T_{y}=0.870, and the polarization degree P=1.00.

In this example, the calculation is conducted using the rectangular prisms having the cross section of the square of 10×sqrt(2) micrometers (10\sqrt{2}μm) on each side and the height of 10 micrometers (μm), and, because the system used in the calculation is in plane symmetry with respect to the z-x plane at y=0 and the two planes at y=−10 micrometers (μ) and at y=10 micrometers (μm) parallel to the z-x plane are perfectly reflecting planes, the same assumption can be made as in the case where the rectangular prisms have the height of infinity and the aspect ratio of infinity, which is the same as in Example 1.

### Example 5

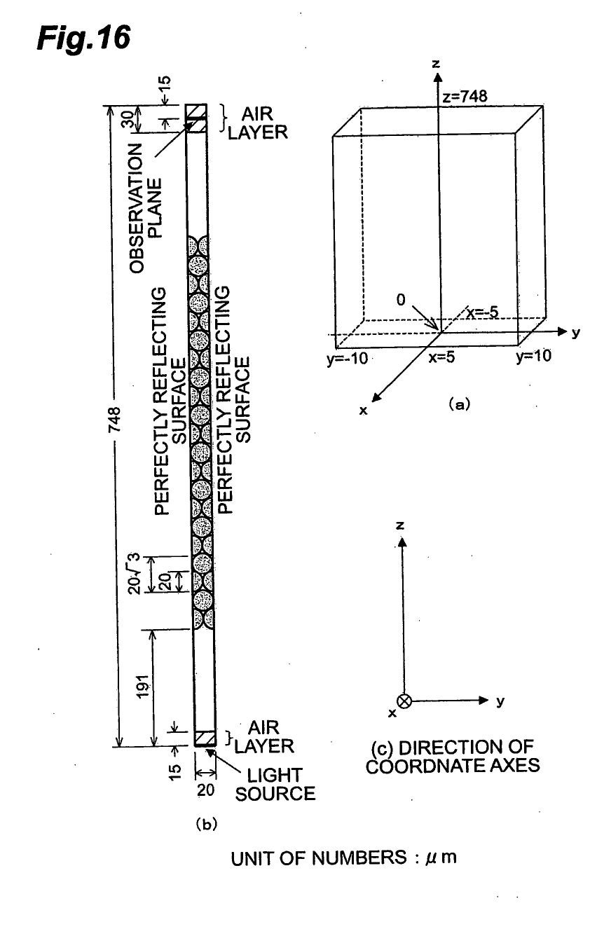

This example shows optical characteristics in the case where circular cylinders with the sectional shape of a circle are closely packed in a total of 21 layers in the thickness direction. The orthogonal coordinate system of the right hand system to express positions in the region is defined by (x,y,z) and the schematic view of the system used in the calculation in this example is presented in FIG. 16. In FIG. 16 part (a) schematically shows a rectangular parallelepiped region used in the calculation, on the right-hand (x,y,z) orthogonal coordinate system, part (b) is a schematic sectional view of this rectangular parallelepiped on the y-z plane at x=0, and part (c) shows the directions of the coordinate axes in part (b). It is noted that in these drawings, particularly, in part (a), the scale size does not correspond to the original size. The unit of numerals in the drawing is micrometer (μm). In part (b), hatched regions represent air layers, light-color circular and semicircular portions represent the layers of the birefringent bodies of the circular cylinders, and white portions represent the layers of the support medium.

The domain used in the calculation is defined by the x-coordinate range of −5 micrometers to 5 micrometers both inclusive, the y-coordinate range of −10 micrometers to 10 micrometers both inclusive, and the z-coordinate range of 0 micrometer to 748 micrometers both inclusive, and is thus inside the rectangular parallelepiped defined below as shown in part (a) in FIG. 16:
−5 μm≦x≦5 μm,
−10 μm≦y≦10 μm, and
0≦z≦748 μm.

Two planes at y=−10 micrometers (μm) and at y=10 micrometers (μm) parallel to the z-x plane are assumed to be perfectly reflecting planes. On the other hand, a light source is defined as a line segment parallel to the y-axis at x=z=0 and in the y-coordinate range of −10 micrometers to 10 micrometers (−10 μm≦y≦10 μm) both inclusive, and the light source generates 5001 rays in the positive direction of the z-axis.

Regions in the calculation domain in the z-coordinate range of 0 to 15 micrometers both inclusive (0≦z≦15 μm) and in the z-coordinate range of 718 micrometers to 748 micrometers both inclusive (718 μm≦z≦748 μm) are defined as air layers (refractive index 1) and a plane parallel to the x-y plane at z=733 micrometers (μm) is defined as an observation plane. A ewrion in the calculation domain in the z-coordinate range of 15 micrometers to 718 micrometers both inclusive (15 μm≦z≦718 μm) is defined as a region of the polarizer and the refractive index thereof is assumed to be 1.4, except for the regions of the circular cylinders described below.

The circular cylinders are those having the refractive index of 1.9, the axis extending in the x-axis direction, the diameter of the bottom faces of 20 micrometers (μm), and the height of 10 micrometers (μm), and one bottom face thereof is set so as to be included in the plane parallel to the y-z plane at x=−5 micrometers (μm). Thirty two circular cylinders are set, and the positions of the respective circular cylinders are defined below by centers of circles in the cross section of each circular cylinder on the y-z plane at x=0.

Namely, the y-coordinates and z-coordinates of the centers of the circles are defined as follows:
(y,z)=(−10,201),
(−10,201+20*sqrt(3)),
(−10,201+40*sqrt(3)),
(−10,201+60sqrt(3),
(−10,201+80*sqrt(3)),
(−10,201+100*sqrt(3)),
(−10,201+120*sqrt(3)),
(−10,201+140*sqrt(3)),
(−10,201+160*sqrt(3)),
(−10,201+180*sqrt(3)),
(−10,201+200*sqrt(3)),
(10,201),
(10,201+20*sqrt(3)),
(10,201+40*sqrt(3)),
(10,201+60*sqrt(3)),
(10,201+80*sqrt(3)),
(10,201+100*sqrt(3)),
(10,201+120*sqrt(3)),
(10,201+140*sqrt(3)),
(10,201+160*sqrt(3)),
(10,201+180*sqrt(3)),
(10,201+200*sqrt(3)),
(0,201+10*sqrt(3)),
(0,201+30*sqrt(3)),
(0,201+50*sqrt(3)),
(0,201+70*sqrt(3)),
(0,201+90*sqrt(3)),
(0,201+110*sqrt(3)),
(0,201+130*sqrt(3)),
(0,201+150*sqrt(3)),
(0,201+170*sqrt(3)),
(0,201+190*sqrt(3)).
However, the above numerals are calculated to six places of decimals, and portions that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are obtained as follows: Tₓ=0.00048, T_{y}=0.944, and the polarization degree P=0.999.

In this example, the calculation is conducted using the circular cylinders having the height of 10 micrometers (μm) and the cross section of the circle with the radius of 10 micrometers (μm) (i.e., the diameter of 20 μm), and the aspect ratio, when calculated literally therefrom, is smaller than 1. However, the system used in the calculation is in plane symmetry with respect to the z-x plane at y=0 and the two planes parallel to the z-x plane at y=−10 micrometers (μm) and at y=10 micrometers (μm) are perfectly reflecting surfaces, which allows the same assumption as in the case where the periodic boundary condition in the y-axis direction is imposed on the system used in the calculation. Therefore, it is the same as the case where the circular cylinders have the height of infinity and the aspect ratio of infinity.

### Example 6

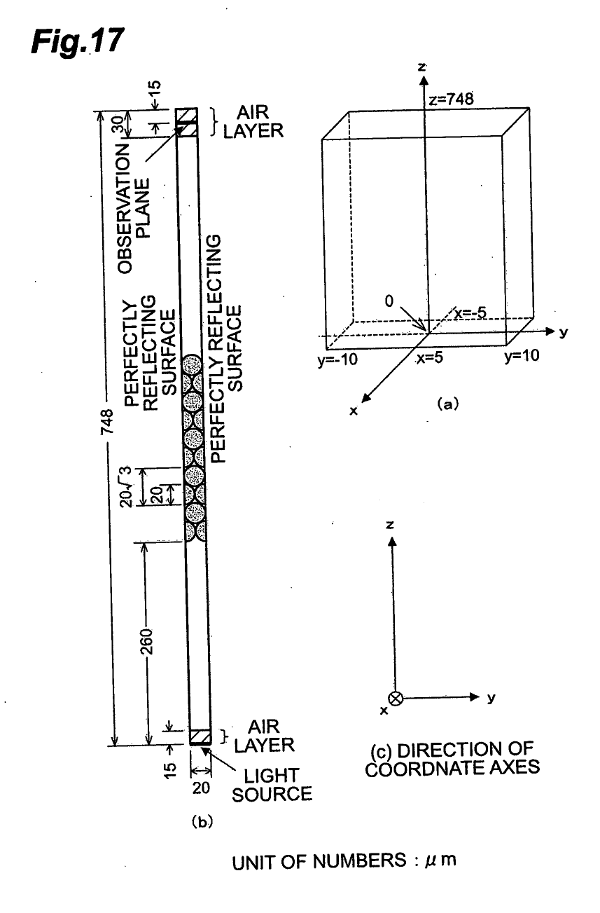

This example shows optical characteristics in the case where circular cylinders with the sectional shape of a circle are closely packed in a total of 10 layers in the thickness direction. The orthogonal coordinate system of the right hand system to express positions in the region is defined by (x,y,z) and the schematic picture of the system used in the calculation in this example is presented in FIG. 17. In FIG. 17 part (a) schematically shows a rectangular parallelepiped region used in the calculation, on the right-hand (x,y,z) orthogonal coordinate system, part (b) is a schematic sectional view of this rectangular parallelepiped on the y-z plane at x=0, and part (c) shows the directions of the coordinate axes in part (b). It is noted that in these figures, particularly, in part (a), the scale size does not correspond to the original size. The unit of numerals in the drawing is micrometer (μ). In part (b), hatched regions represent air layers, light-color circular and semicircular portions represent the layers of the birefringent bodies of the circular cylinders, and white portions represent the layers of the support medium.

The domain used in the calculation is defined by the x-coordinate range of −5 micrometers to 5 micrometers both inclusive, the y-coordinate range of −10 micrometers to 10 micrometers both inclusive, and the z-coordinate range of 0 micrometer to 748 micrometers both inclusive, and is thus inside the rectangular parallelepiped defined below as shown in part (a) in FIG. 17:
−5 μm≦x≦5 μm,
−10 μm≦y≦10 μm,and
0≦z≦748 μm.

Two planes at y=−10 micrometers (μm) and at y=10 micrometers (μm) parallel to the z-x plane are assumed to be perfectly reflecting planes. On the other hand, a light source is defined as a line segment parallel to the y-axis at x=z=0 and in the y-coordinate range of −10 micrometers to 10 micrometers (−10 μm≦y≦10 μm) both inclusive, and the light source generates 5001 rays in the positive direction of the z-axis.

Regions in the calculation domain in the z-range of 0 to 15 micrometers both inclusive (0≦z≦15 μm) and in the z-range of 718 micrometers to 748 micrometers both inclusive (718 μm≦z≦748 μm) were defined as air layers (refractive index 1) and a plane parallel to the x-y plane at z-733 micrometers (μm) is defied as an observation plane. A region in the calculation domain in the z-coordinate range of 15 micrometers to 718 micrometers both inclusive (15 μm≦z≦718 μm) is defined as a region of the polarizer and the refractive index thereof is assumed to be 1.6, except for the regions of the circular cylinders described below.

The circular cylinders are those having the refractive index of 2.3, the axis extending in the x-axis direction, the diameter of the bottom faces of 20 micrometers (μm), and the height of 10 micrometers (μm), and one bottom face thereof is set so as to be included in the plane parallel to the y-z plane at x=−5 micrometers (μm). Fifteen circular cylinders are set, and the positions of the respective circular cylinders are defined below by centers of circles in the cross section of each circular cylinder on the y-z plane at x=0.

Namely, the y-coordinates and z-coordinates of the centers of the circles are defined as follows:
(y,z)=(−10,270),
(−10,270+20*sqrt(3)),
(−10,270+40*sqrt(3)),
(−10,270+60*sqrt(3)),
(−10,270+80*sqrt(3)),
(10,270),
(10,270+20*sqrt(3)),
(10,270+40*sqrt(3)),
(10,270+60*sqrt(3)),
(10,270+80*sqrt(3)),
(0,270+10*sqrt(3)),
(0,270+30*sqrt(3)),
(0,270+50*sqrt(3)),
(0,270+70*sqrt(3)),
(0,270+90*sqrt(3)).
However, the above numerals are calculated to six places of decimals, and portions of the numerals that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are obtained as follows: Tₓ=0.049, T_{y}=0.895, and the polarization degree P=0.896.

In this example, the calculation is also conducted using the circular cylinders having the cross section of the circle with the radius of 10 micrometers (μm) (i.e., the diameter of 20 μm) and the height of 10 micrometers (μm), and, because the system used in the calculation is in plane symmetry with respect to the z-x plane at y=0 and the two planes parallel to the z-x plane at y=−10 micrometers (μm) and at y=10 micrometers (μm) are perfectly reflecting planes, the same assumption can be made as in the case where the circular cylinders have the height of infinity and the aspect ratio of infinity, as in Example 1.

### Comparative Example 1

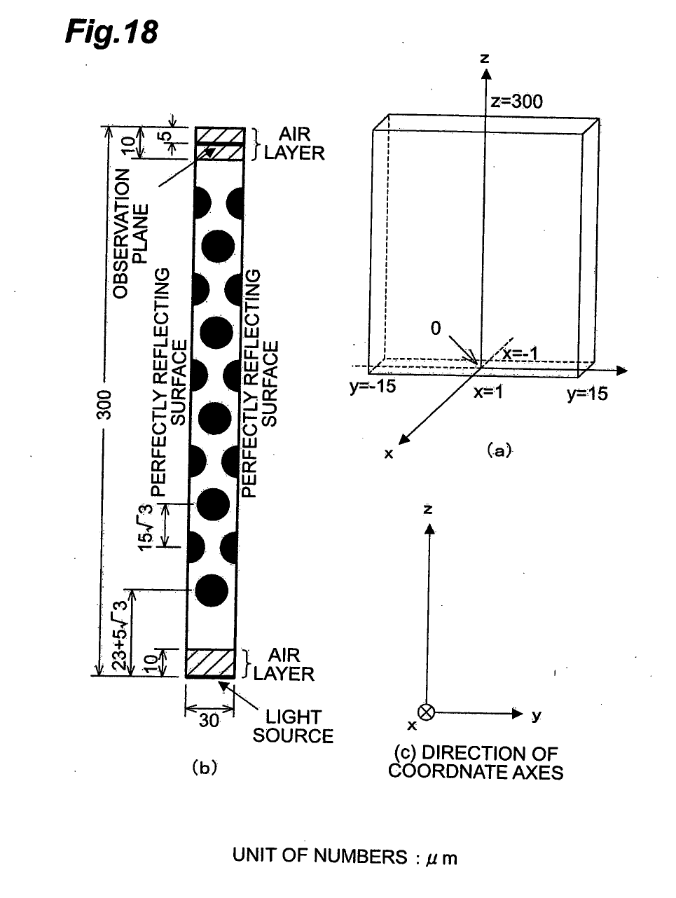

This example shows optical characteristics in the case where circular cylinders are uniformly dispersed in the same direction in the support medium. The orthogonal coordinate system of the right hand system to express positions in the region is defined by (x,y,z) and the schematic picture of the system used in the calculation in this example is presented in FIG. 18. In FIG. 18 part (a) schematically shows a rectangular parallelepiped region used in the calculation, on the right-hand (x,y,z) orthogonal coordinate system, part (b) is a schematic sectional view of this rectangular parallelepiped on the y-z plane at x=0, and part (c) shows the directions of the coordinate axes in part (b). It is noted that in these drawings, particularly, in part (a), the scale size does not correspond to the original size. The unit of numerals in the drawing is micrometer (μm). In part (b), hatched regions represent air layers, blackened portions represent the layers of the circular cylinders, and white portions represent the layers of the support medium.

The domain used in the calculation is defined by the x-coordinate range of −1 micrometer to 1 micrometer both inclusive, the y-coordinate range of −15 micrometers to 15 micrometers both inclusive, and the z-coordinate range of 0 micrometer to 300 micrometers both inclusive, and is thus inside the rectangular parallelepiped defined below as shown in part (a) in FIG. 18:
−1 μm≦x≦1 μm,
−15 μm≦y≦15 μm, and
0≦z≦300 μm.

Two planes at y=−15 micrometers (μm) and at y=15 micrometers (μm ) parallel to the z-x plane are assumed to be perfectly reflecting planes. On the other hand, a light source is defined as a line segment parallel to the y-axis at x=z=0 and in the y-coordinate range of −15 micrometers to 15 micrometers (−15 μm≦y≦15 μm) both inclusive, and the light source generates 5001 rays in the positive direction of the z-axis.

Regions in the calculation domain in the z-coordinate range of 0 to 10 micrometers both inclusive (0≦z≦10 μm) and in the z-coordinate range of 290 micrometers to 300 micrometers both inclusive (290 μm≦z≦300 μm) are defined as air layers (refractive index 1) and a plane parallel to the x-y plane at z=295 micrometers (μm) is defined as an observation plane. A region in the calculation domain in the z-coordinate range of 10 micrometers to 290 micrometers both inclusive (10 μm≦z≦290 μm) is defined as a region of the polarizer and the refractive index thereof is assumed to be 1.6, except for the regions of the circular cylinders described below.

The circular cylinders are those having the refractive index of 2.3, the axis extending in the x-axis direction, the radius of the bottom faces of 10 micrometers (μm), and the height of 2 micrometers (μm), and one bottom face thereof is set so as to be included in the plane parallel to the y-z plane at x=−1 micrometer (μm). Fifteen circular cylinders are set, and the positions of the respective circular cylinders are defined below by centers of circles in the cross section of each circular cylinder on the y-z plane at x=0.

Namely, the y-coordinates and z-coordinates of the centers of the circles are defined as follows:
(y,z)=(0,23+5*sqrt(3)),
(−15,23+20*sqrt(3)),
(15,23+20*sqrt(3)),
(0,23+35*sqrt(3)),
(−15,23+50*sqrt(3)),
(15,23+50*sqrt(3)),
(0,23+65*sqrt(3)),
(−15,23+80*sqrt(3)),
(15,23+80*sqrt(3)),
(0,23+95*sqrt(3)),
(−15,23+110*sqrt(3)),
(15,23+110*sqrt(3)),
(0,23+125*sqrt(3)),
(−15,23+140*sqrt(3)),
(15,23+140*sqrt(3)),
However, the above numerals are calculated to six places of decimals, and portions of the numerals that are off the domain used in the calculation are ignored.

With the above-described calculation system, the transmittance Tₓ for the polarized light with the electric field vector parallel to the x-axis, and the transmittance T_{y} for the polarized light with the electric field vector parallel to the y-axis are calculated in the same manner as in Example 1, and the results are obtained as follows: Tₓ=0.390, T_{y}=0.896, and the polarization degree P=0.393.

In this example, the calculation is also conducted using the circular cylinders having the cross section of the circle with the radius of 10 micrometers (μm) (i.e., the diameter of 20 μm) and the height of 2 micrometers (μm), and, because the system used in the calculation is in plane symmetry with respect to the z-x plane at y=0 and the two planes parallel to the z-x plane at y=−15 micrometers (μm) and at y=15 micrometers (μm) are assumed to be perfectly reflecting planes, the same assumption can be made as in the case where the circular cylinders have the height of infinity and the aspect ratio of infinity, as in Example 1.

Industrial Applicability

The reflective polarizer of the present invention can form the structure in which the birefringent bodies are dispersed and oriented substantially in one direction by a simple method and is unlikely to cause delamination, by virtue of the configuration wherein the interfaces between different materials are not simple planes. In addition, the support medium for fixing the birefringent bodies is constructed of the isotropic substance, and the reduction of strength is relatively small with increase in the volume fraction of the birefringent bodies, whereby it is easy to increase the volume fraction of the birefringent bodies. Furthermore, when this reflective polarizer is located on the other side than the observer side of the liquid crystal panel where the absorptive polarizer is provided, the efficiency of utilization of light is so high as to enable provision of the liquid crystal display apparatus with high luminance and low power consumption.

1. A reflective polarizer comprising:
plural birefringent bodies each having one of a polygonal prism and a circular cylinder whose cross section perpendicular to a major axis direction thereof has a shape of polygon or substantially circular, the shape of the cross section having an aspect ratio of not less than 2, and the birefringent bodies having a refractive index difference of not less than 0.05 between a refractive index component in the long axis direction and a refractive index component in a minor axis direction of the birefringent bodies,
wherein the plural birefringent bodies are dispersedly arranged substantially in one direction in a support medium, and
wherein, where the shape of the cross section perpendicular to the major axis direction of the birefringent bodies is substantially circular, in the cross section, any one of the plural birefringent bodies is in contact on a side face thereof with each of at least two other birefringent bodies in contact on a side face thereof with each other.

2-29. (canceled)

30. The reflective polarizer according to claim 1, wherein the cross section of each birefringent body is a polygon.

31. The reflective polarizer according to claim 1, wherein the cross section of each birefringent body is substantially circular.

32. The reflective polarizer according to claim 1, wherein the birefringent bodies are made of fibers, respectively, and a shape of a cross section of each fiber perpendicular to the major axis direction thereof is polygonal.

33. The reflective polarizer according to claim 32, wherein each of fibers has a sectional shape of a triangle and lengths of at least two sides of the triangle are substantially equal to each other,
wherein the fibers are arranged such that the fibers are substantially parallel in a plane and such that apexes of sectional triangles of fibers adjacent to each other are in contact with each other, and
wherein, in a cross section of the reflective polarizer perpendicular to the major axis, the support medium surrounded by fibers of sectional triangles with apexes in contact with each other is of a hexagon.

34. The reflective polarizer according to claim 32, wherein each of the fibers has a sectional shape of substantially a regular triangle,
wherein the fibers are arranged such that the fibers are substantially parallel in a plane and that apexes of sectional regular triangles of fibers adjacent to each other are in contact with each other, and
wherein in a cross section of the reflective polarizer perpendicular to the major axis, the support medium surrounded by fibers of sectional triangles with apexes in contact with each other is substantially of a regular hexagon.

35. The reflective polarizer according to claim 32, wherein each of the fibers has a sectional shape of a triangle and lengths of at least two sides of the triangle are substantially equal to each other,
wherein the fibers are arranged such that the fibers are substantially parallel in a plane and that apexes of sectional triangles of adjacent fibers are in contact with each other, and
wherein in a cross section of the reflective polarizer perpendicular to the major axis, the support medium surrounded by fibers of sectional triangles with apexes in contact with each other is a triangle lengths of two sides of which are substantially equal.

36. The reflective polarizer according to claim 32, wherein each of the fibers has a sectional shape of a quadrangle and lengths of four sides of the quadrangle are substantially equal to each other,
wherein the fibers are arranged such that the fibers are substantially parallel in a plane and such that apexes of sectional quadrangles of adjacent fibers are in contact with each other, and
wherein, in a cross section of the reflective polarizer perpendicular to the major axis, the support medium surrounded by fibers of sectional quadrangles with apexes in contact with each other is a quadrangle and lengths of four sides of the quadrangle are substantially equal to each other.

37. The reflective polarizer according to claim 1, wherein, in the cross section perpendicular to the major axis direction thereof, the shape of each birefringent body is a substantially circle, and a triangle defined by connecting centers of three circles in direct contact in the cross section has at least two sides substantially equal to each other in length.

38. The reflective polarizer according to claim 37, wherein the triangle defined by connecting the centers of the three circles in direct contact in the cross section perpendicular to the major axis direction has three sides substantially equal to each other.

39. The reflective polarizer according to claim 37, wherein the shapes of the birefringent bodies are respective circular cylinders, and the circular cylinders have substantially equal diameters in the cross section perpendicular to the major axis direction, and some of the circular cylinders located in a medial region to an outermost thereof in the cross section is in contact on a side face thereof with six other circular cylinders for the birefringent bodies.

40. The reflective polarizer according to claim 37, wherein the birefringent bodies are respective fibers.

41. The reflective polarizer according to claim 40, wherein, in the birefringent bodies, either one of a refractive index component in the major axis direction thereof and a refractive index component in a minor axis direction thereof is substantially equal to a refractive index of the support medium.

42. The reflective polarizer according to claim 1, wherein, in the birefringent bodies, either one of a refractive index component in the major axis direction and a refractive index component in a short axis direction is substantially equal to a refractive index of the support medium.

43. A laminated optical member comprising the reflective polarizer as set forth in claim 1, wherein the reflective polarizer is laminated with an optical layer having another optical function.

44. A laminated optical member comprising the reflective polarizer as set forth in claim 40, wherein the reflective polarizer is laminated with an optical layer having another optical function.

45. A laminated optical member comprising the reflective polarizer as set forth in claim 43, wherein the reflective polarizer is laminated with an optical layer having another optical function.

46. The laminated optical member according to claim 43, wherein the optical layer is an absorptive polarizer.

47. The laminated optical member according to claim 44, wherein the optical layer is an absorptive polarizer.

48. The laminated optical member according to claim 45, wherein the optical layer is an absorptive polarizer.

49. The laminated optical member according to claim 43, wherein the optical layer is a retardation plate.

50. The laminated optical member according to claim 44, wherein the optical layer is a retardation plate.

51. The laminated optical member according to claim 45, wherein the optical layer is a retardation plate.

52. The laminated optical member according to claim 43, wherein an absorptive polarizer is provided on one surface of the reflective polarizer and a retardation plate is provided on another surface of the reflective polarizer.

53. The laminated optical member according to claim 44, wherein an absorptive polarizer is provided on one surface of the reflective polarizer and a retardation plate is provided on another surface of the reflective polarizer.

54. The laminated optical member according to claim 45, wherein an absorptive polarizer is provided on one surface of the reflective polarizer and a retardation plate is provided on another surface of the reflective polarizer.

55. A liquid crystal display apparatus comprising the laminated optical member as set forth in claim 43, wherein the laminated optical member is provided in a liquid crystal cell.

56. A liquid crystal display apparatus comprising the laminated optical member as set forth in claim 44, wherein the laminated optical member is provided in a liquid crystal cell.
